(19) United States
(12) Patent Application Publication
(10) Pub. No.: US 2009/0295822 A1
(43) Pub. Date: Dec. 3, 2009

(54) DISPLAY APPARATUS, METHOD FOR DISPLAYING IMAGE AND RECORDING MEDIUM STORING PROGRAM FOR DISPLAYING IMAGE

(75) Inventor: Natsuo OKADA, Osaka-shi (JP)

Correspondence Address: BIRCH STEWART KOLASCH & BIRCH, PO BOX 747, FALLS CHURCH, VA, 22040-0747, US

(73) Assignee: DIGITAL ELECTRONICS CORPORATION, Osaka-Shi (JP)

(21) Appl. No.: 12/475,154

(22) Filed: May 29, 2009

(30) Foreign Application Priority Data
May 30, 2008 (JP) 2008-142921
Mar. 27, 2009 (JP) 2009-079703

(51) Int. Cl. G09G 5/02

(52) U.S. Cl. 345/589

(57) ABSTRACT

Change of the color of an image of a part shown in a screen of a display apparatus is facilitated. A screen editor apparatus includes a storage unit, a control unit and a display unit. The storage unit includes image data for displaying an image of a part, palette data for displaying a color palette, a drawing editor, and a program editor. The control unit includes a display control unit for causing the display unit to display the palette based on the palette data, an association unit for associating a selected hue with an image, and a screen data generation unit for generating screen data using the drawing editor, based on the data generated by the association unit.

This nonprovisional application is based on Japanese Patent Application No. 2008-142921 filed on May 30, 2008 and No. 2009-079703 filed on Mar. 27, 2009 with the Japan Patent Office, the entire contents of which are hereby incorporated by reference.

### BACKGROUND OF THE INVENTION

1. Field of the Invention

The present invention relates to display of an image on a display apparatus, and more particularly to a technique for displaying an image in a color different from a prepared color of the image.

2. Description of the Background Art

An industrial control apparatus called programmable logic controller (PLC) is connected to an apparatus, machine, device or the like to be controlled such as automatic assembly machine (hereinafter “control target apparatus”), performs control such as sequence control on the control target apparatus, or receives data indicating a status of the control target apparatus. The control target apparatus is controlled or the status of the control target apparatus is displayed via a display apparatus having the capability of displaying a status of the apparatus and the capability of controlling an operation of the apparatus, for example. In these years, a display apparatus having the control capability of the above-described industrial control apparatus is also employed.

Such a display apparatus presents a screen for displaying a status of a control target apparatus connected to the display apparatus or allowing an operator to enter an instruction. Screen data displayed on the screen is produced through programming prepared by a screen editor apparatus.

The screen data thus produced often includes a plurality of images associated with variables. The variables are respectively set according to respective statuses of the control target apparatus or respective operations to be controlled. It is thus desired to create a program by efficiently setting a plurality of variables in producing or editing screen data.

Japanese Patent Laying-Open No. 2003-150212 for example discloses a screen editor apparatus achieving enhanced flexibility by allowing a user to set respective functions of parts shown on a screen. The screen editor apparatus “associates a variable with an I/O address of a PLC 2 to which an input/output device 4 is connected, or with an internal device of a programmable display apparatus 1 and, when programmable display apparatus 1 obtains the status of input/output device 4 from PLC 2 according to the I/O address or obtains the status of the internal device, the status is reflected on a part shown on the screen via the variable. Such a screen is produced as screen data by means of a drawing editor 32a of a computer apparatus 3. When an attribute (such as color, size, angle) of a part on the screen is to be changed, the user specifies the part with a parts editor 32b activated, and rewrites the definition of the attribute of the part in a program code describing the specified part” (SOLUTION of the abstract).

According to the technique disclosed in Japanese Patent Laying-Open No. 2003-150212, the attribute of the part is rewritten in the program code. How the program code has been rewritten, however, cannot be confirmed until a screen based on the program code is displayed. If the program code is erroneously rewritten, the program code may not be rewritten as intended by the user.

Further, parts are usually prepared by the manufacturer of the screen editor apparatus. In order to use a part that has not been prepared, the user has to ask the manufacturer to develop the part or the user has to create the part. It is supposed here by way of example that an image of a lamp with a color of red is provided in advance as a standard part. If the user of the screen editor apparatus is to use lamp images of other colors (such as blue, yellow, green), the user has to create lamp images of respective colors. In this case, the screen efficiency is hindered from being improved. Furthermore, for those users unaccustomed to operating common bit map image edit software (such as Adobe (registered trademark), Photoshop (registered trademark) or the like), or those users without a talent for drawing or painting, it is considerably difficult to create an image similar to the image provided in advance as a standard part.

In the case where the provider of the screen editor apparatus or screen edit software prepares each of colors for a part supposed to be used, the user may be confused, because many parts that may not be used eventually could be included and the user may not be able to easily find an image of a part that the user wants to use.

Accordingly, there has been a need for a display apparatus that can easily display an image using a plurality of colors. Further, there has been a need for a display method for displaying an image according to which an image can be easily displayed using a plurality of colors. Furthermore, there has been a need for a recording medium storing a program for causing a computer to implement the display method.

### SUMMARY OF THE INVENTION

In summary, a display apparatus according to an embodiment is connectable to a control target apparatus. The display apparatus includes: a display main body; a transmitter for transmitting an instruction to the control target apparatus; an input unit for receiving input of data that is output by the control target apparatus; a memory configured to store first color data specifying a color attribute designated as a target to be acquired in an image displayed on the display main body; and a processor coupled to the memory. The processor is configured to: acquire the first color data in the image displayed on the display main body, based on the data output by the control target apparatus; determine whether it is necessary to change the first color data in the image displayed on the display main body; and change the color attribute of the first color data when the processor determines that it is necessary to change the first color data.

Preferably, the memory is further configured to store second color data specifying a color attribute. The processor is further configured to change the color attribute of the first color data to the color attribute of the second color data.

Preferably, the memory is further configured to store a plurality of color data. The processor is further configured to: produce a color data table arranging a predetermined number of color data in descending order in terms of size of an area occupied by the color data in the image displayed on the display main body; cause the display main body to display the color data table; and receive selection for setting the first color data.

According to another embodiment, a method for displaying an image is provided. The method includes the steps of: loading, into a memory, first color data for specifying a color attribute designated as a target to be acquired in an image displayed on a display apparatus; acquiring the first color data in the image displayed on the display apparatus, based on data that is output by a control target apparatus connected to the display apparatus; determining whether it is necessary to change the first color data in the image displayed on the display apparatus; and changing the color attribute of the first color data when determining that it is necessary to change the first color data.

Preferably, the method further includes the steps of: loading, into the memory, second color data specifying a color attribute; and changing the color attribute of the first color data to the color attribute of the second color data.

Preferably, the method further includes the steps of: loading a plurality of color data into the memory; producing a color data table arranging a predetermined number of color data in descending order in terms of size of an area occupied by the color data in the image displayed on the display apparatus; causing the display main body to display the color data table; and receiving selection for setting the first color data.

According to still another embodiment, a computer-readable recording medium storing a program for causing the method as described above to be executed is provided.

According to a further embodiment, a display apparatus is provided for displaying a status indication image indicating a status of a control target apparatus, based on input of a status indication value indicating the status of the control target apparatus. The display apparatus includes: a display unit; a storage unit configured to store: a reference value set in advance as a criterion for a value indicating a status of the control target apparatus; a group of first color data including a plurality of color data selectable as an attribute of a display color for at least a part of the status indication image displayed until the status indication value reaches the reference value; and a group of second color data including a plurality of color data selectable as an attribute of a display color for at least a part of the status indication image displayed when the status indication value exceeds the reference value; and a controller configured to cause a display main body to display at least a part of the status indication image with the first color data, and cause the display main body to display at least a part of the status indication image with the second color data when the status indication value exceeds the reference value.

Preferably, the display apparatus further includes a volatile memory for storing the reference value.

Preferably, at least one of the first color data and the second color data is input from outside the display apparatus.

Preferably, the storage unit is further configured to store a group of images including a plurality of sample images selectable as the status indication image. The display apparatus further includes an editor configured to edit screen data. The editor is further configured to: cause the display main body to display a sample image; receive selection input for selecting first color data to be changed, from at least one color data constituting the sample image; cause the display main body to display a plurality of color data candidates available as color data when the status indication value exceeds the reference value; receiving selection input for selecting second color data to which the first color data is to be changed, from a plurality of color data candidates; and produce screen data for displaying a portion displayed with the first color data, with the second color data when the status indication value exceeds the reference value.

Preferably, the editor is further configured to cause the display main body to display a palette including a plurality of color data as a plurality of color data candidates. Preferably, the editor is further configured to cause the display main body to display a list of a plurality of color data as a plurality of color data candidates.

Preferably, the editor is further configured to calculate a ratio between constituent color data constituting a sample image, based on a bit map constituting the sample image, and cause the display main body to display the constituent color data in an order based on the ratio.

According to a further embodiment, a screen editor apparatus is provided for producing screen data used by a display program executed by the display apparatus as described above. The screen editor apparatus includes: a memory for storing a plurality of sample images selectable as a status indication image, and a screen edit program; an input interface for receiving input of an instruction; a display main body; and a processor coupled to the memory. The processor is configured to: cause the display main body to display a sample image by executing the screen edit program; receive input for selecting first color data to be changed, from attributes of display colors of the sample image; cause the display main body to display a plurality of color data candidates available as second color data; receive input for selecting second color data from the plurality of color data candidates; and produce the screen data for displaying a portion displayed with the first color data, with the second color data when the status indication value exceeds a reference value.

Preferably, the processor is further configured to cause the display main body to display a palette including a plurality of color data as a plurality of color data candidates. Preferably, the processor is further configured to cause the display main body to display a list of a plurality of color data as the plurality of color data candidates.

Preferably, the processor is further configured to calculate a ratio between constituent color data constituting a sample image based on a bit map constituting the sample image, and cause the display main body to display the constituent color data in an order based on the ratio.

According to a further embodiment, a method for displaying an image indicating a status of a control target apparatus is provided. The method includes the steps of: loading a status indication image, a reference value set in advance as a criterion for a value indicating the status of the control target apparatus, a group of first color data including a plurality of color data selectable as an attribute of a display color for at least a part of the status indication image displayed until a status indication value reaches the reference value, and a group of second color data including a plurality of color data selectable as an attribute of a display color for at least a part of the status indication image displayed when the status indication value exceeds the reference value; selecting first color data from the group of first color data and selecting second color data from the group of second color data; and causing a display main body to display a portion displayed with the first color data, with the second color data when the status indication value exceeds the reference value.

According to a further embodiment, a program for causing a computer to implement a method for displaying an image indicating a status of a control target apparatus is provided. The program causes the computer to execute the steps of: loading a status indication image, a reference value set in advance as a criterion for a value indicating the status of the control target apparatus, a group of first color data including a plurality of color data selectable as an attribute of a display color for at least a part of the status indication image displayed until a status indication value reaches the reference value, and a group of second color data including a plurality of color data selectable as an attribute of a display color for at least a part of the status indication image displayed when the status indication value exceeds the reference value; selecting first color data from the group of first color data and selecting second color data from the group of second color data; and causing a display main body to display a portion displayed with the first color data, with the second color data when the status indication value exceeds the reference value.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates how a screen editor apparatus 100, a programmable display apparatus 150 executing a program generated by screen editor apparatus 100, and a PLC (programmable logic controller) 180 are connected to each other.

FIG. 2 is a block diagram illustrating a configuration of functions implemented by a screen editor apparatus.

FIG. 3 conceptually illustrates a structure of a data block.

FIG. 4 illustrates a structure of an acquisition target color block.

FIG. 5 conceptually illustrates a structure of a control block.

FIG. 6 conceptually illustrates a structure of a display color block.

FIG. 7 conceptually illustrates a structure of a color attribute change control table.

FIGS. 8A-8D illustrate a manner in which a display apparatus displays an image.

FIG. 9 conceptually illustrates respective structures of color attribute change control tables stored in a memory of a display apparatus.

FIGS. 10-13 are each a flowchart illustrating a part of a series of processes executed by a CPU.

FIG. 14 conceptually illustrates a manner in which data is stored in a VRAM.

FIGS. 15A-15D each illustrate an image displayed on a display apparatus.

FIG. 16 conceptually illustrates respective structures of tables stored in a display apparatus.

FIGS. 17-20 are each a flowchart illustrating a part of a series of processes executed by a CPU implementing a display apparatus.

FIG. 21 conceptually illustrates a manner in which data is stored in a VRAM.

FIG. 22 illustrates an image prepared for a display apparatus to present the image on a display.

FIG. 23 conceptually illustrates a structure of a table stored by a display apparatus in a memory.

FIG. 24 illustrates a manner in which an image is presented on a display.

FIGS. 25-28 are each a flowchart illustrating a part of a series of processes executed by a CPU for implementing a display apparatus according to another aspect of the present invention.

FIG. 29 conceptually illustrates a manner in which data is stored in a VRAM of a display apparatus.

FIGS. 30A-30C illustrate a relation between a pixel including a blue element and a pixel including a green element.

FIG. 31 conceptually illustrates a manner in which data is stored in a hard disk of a screen editor apparatus according to a second embodiment of the present invention.

FIGS. 32 and 33 each illustrate a table illustrating effects achieved through change of color data.

FIG. 34 is a flowchart illustrating a part of a process executed by a CPU of a screen editor apparatus.

FIG. 35 illustrates a relation between addresses assigned to respective devices.

FIGS. 36 and 37 each illustrate an example of a screen displayed on a monitor.

FIG. 38 is a flowchart illustrating a part of a series of processes executed by a CPU of a display apparatus.

FIG. 39 is a block diagram illustrating a configuration of functions implemented by a display apparatus.

FIG. 40 conceptually illustrates a manner in which data is stored in a storage unit of a display apparatus.

FIG. 41 conceptually illustrates a manner in which data is stored in a nonvolatile memory of a control target apparatus.

FIG. 42 is a flowchart illustrating a part of a series of processes executed by a CPU.

### DESCRIPTION OF THE PREFERRED EMBODIMENTS

Embodiments of the present invention will be described hereinafter with reference to the drawings. In the following description, like components are denoted by like reference characters. They are similarly named, and similarly function as well. Therefore, a detailed description thereof will not be repeated.

### First Embodiment

### Hardware Configuration

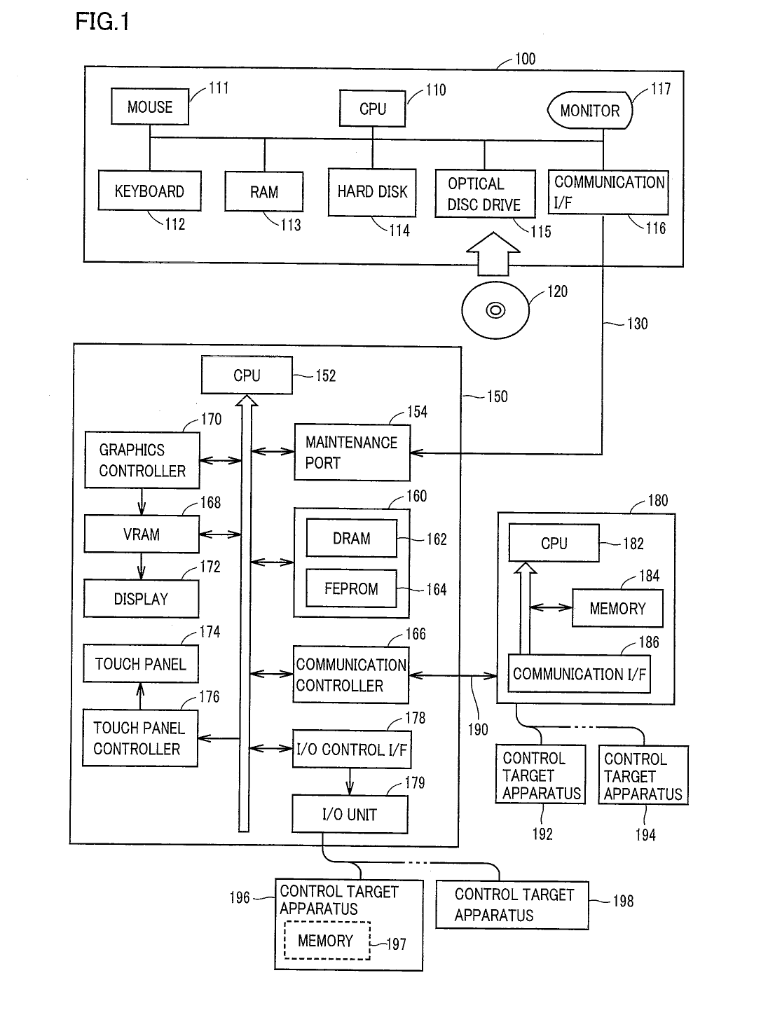

Referring to FIG. 1, a description will be given of a hardware configuration of a screen editor apparatus 100 according to a first embodiment. Screen editor apparatus 100 and a display apparatus 150 may be connected by a communication line 130. This connection may be established when data (executable program, screen data) is transmitted from screen editor apparatus 100 to display apparatus 150, and it is unnecessary that screen editor apparatus 100 and display apparatus 150 are always connected. Instead of communication line 130, therefore, a removable recording medium may be used.

Screen editor apparatus 100 is implemented for example by a computer system having a well-known configuration. Screen editor apparatus 100 includes a CPU 110, a mouse 111, a keyboard 112, a RAM (Random Access Memory) 113, a hard disk 114, an optical disc drive 115, a communication I/F (Interface) 116, and a monitor 117. On optical disc drive 115, an optical disc such as CD-ROM (Compact Disc-Read Only Memory) 120 can be mounted.

CPU 110 performs a predetermined process or control based on an instruction given to screen editor apparatus 100. Mouse 111 and keyboard 112 receive input of an instruction to screen editor apparatus 100. RAM 113 temporarily (in a volatile manner) stores data generated by CPU 110 or data provided to screen editor apparatus 100. Hard disk 114 stores data generated by CPU 110 or data provided to screen editor apparatus 100 in nonvolatile manner. Optical disc drive 115 reads data from an optical disc (CD-ROM 120 for example) mounted on the disc drive or writes data on a medium where data can be written, such as DVD (Digital Versatile Disc). Communication I/F 116 communicates with another information communication device (such as display apparatus 150) via a wire or by radio. Monitor 117 displays screen data and an image based on data generated by CPU 110 or data provided to screen editor apparatus 100.

A process in screen editor apparatus 100 is implemented by the hardware and software executed by CPU 110. Such software may be stored in advance on hard disk 114 in some cases. The software may also be a commercially available program product stored on a data recording medium such as CD-ROM 120 in some cases. Further, the software may also be provided as a downloadable program product by an information provider connected to the so-called Internet in some cases. Such software is read by a reader such as optical disc drive 115 from the recording medium or downloaded via communication I/F 116, and then temporarily stored on hard disk 114. The software is read by CPU 110 from hard disk 114 and stored in RAM 113 in the form of an executable program. CPU 110 executes the program.

A computer system implementing screen editor apparatus 100 shown in FIG. 1 is a commonly used computer system. In other words, the most essential elements of the present invention may therefore be the software stored on a data recording medium such as RAM 113, hard disk 114, CD-ROM 120 or the like, or the software that can be downloaded via a network. Here, the operation of the hardware of the computer system implementing screen editor apparatus 100 is well known. Thus, a detailed description of the hardware operation will not be repeated.

Display apparatus 150 includes a CPU 152, a maintenance port 154, a memory 160, a communication controller 166, a VRAM (Video RAM) 168, a graphics controller 170, a display 172, a touch panel 174, a touch panel controller 176, an I/O (Input/Output) control I/F (Interface) 178, and an I/O unit 179, connected to each other via a data bus. Display apparatus 150 is electrically connected to control target apparatuses (apparatuses to be controlled) 196, 198 such that the display apparatus and the control target apparatuses can communicate with each other. Control target apparatus 196 may include a memory 197.

Memory 160 includes a DRAM (Dynamic RAM) 162 and an FEPROM (Flash Erasable and Programmable ROM) 164. I/O unit 179 includes such elements as input/output terminal and input/output circuit for connecting an apparatus such as control target apparatuses 196, 198. A plurality of input/output terminals may be provided. I/O control I/F 178 is an interface circuit serving as an interface for communicating a signal between CPU 152 and I/O unit 179. I/O control I/F 178 includes such elements as input/output memory, D/A (Digital to Analog) converter, A/D (Analog to Digital) converter for example.

CPU 152 performs a process for communication with PLC 180 and a display process for display 172, for example, based on a program stored in FEPROM 164. Based on the input at touch panel 174, CPU 152 further performs a process for the input.

Maintenance port 154 is temporarily used for maintenance or the like of display apparatus 150. In such cases where screen data to be displayed on display apparatus 150 is to be changed or setting for display control for the screen data is to be changed, for example, new data is input from maintenance port 154. Accordingly, the screen data can be updated without hampering communication between display apparatus 150 and PLC 180.

DRAM 162 mainly and temporarily stores data used for display control for display 172, for example. CPU 152 reads color data stored in FEPROM 164 into DRAM 162. The color data includes acquisition target color data (namely color data to be changed) constituting an image, and display color data to which the color data is to be changed. CPU 152 compares actual data (status indication value) indicating a status of control target apparatuses 192, 194, 196, 198 with a reference value that is set in advance as a criterion for the status, and changes the attribute of the color of the image, according to the result of the comparison. The reference value is used as a criterion based on which it is determined whether or not the attribute of the color is to be changed.

More specifically, the reference value may be set such that CPU 152 changes the attribute of the color when the status indication value and the reference value are identical to each other. Alternatively, the reference value may be set such that CPU 152 changes the attribute of the color when the status indication value is larger than the reference value. Alternatively, the reference value may be set such that CPU 152 changes the attribute of the color when the status indication value is smaller than the reference value. FEPROM 164 is a rewritable flash memory. Since the flash memory has no moving component and is resistant to impact, the flash memory can operate stably even if display apparatus 150 is connected to PLC 180 in a harsh environment.

“Color data” in the present embodiment refers to data indicating one of attributes (such as R, G, B, hue, saturation, luminance) in various color spaces such as RGB color space, HSL color space, HSV color space.

FEPROM 164 stores a color code (color data) defining a color of an image presented on display 172. CPU 152 uses the code to write image data to be presented on display 172 into VRAM 168. More specifically, CPU 152 selects a color code according to data indicating the status of control target apparatuses 192, 194, 196, 198 and the reference value and generates image data using the selected color code.

Communication controller 166 communicates data to and from PLC 180 under control by CPU 152. The data to be communicated includes data indicating operating status such as actual performance or the like reported by PLC 180, or setting data or the like transmitted from display apparatus 150 to PLC 180.

VRAM 168 temporarily stores data to be displayed on the screen under control of CPU 152. The data is read into graphics controller 170 and output to display 172. Thus, display 172 can present predetermined screen data.

Touch panel controller 176 is disposed between touch panel 174 and the data bus to detect pressing of touch panel 174. When touch panel controller 176 detects the pressing, the position or the input data is output to memory 160.

As seen from the above-described configuration, display apparatus 150 has I/O control I/F 178 and I/O unit 179, and thus display apparatus 150 can be connected to a control target apparatus without PLC 180 therebetween. Display apparatus 150 therefore can directly manage display of the status of control target apparatuses 196, 198 or control of the operation thereof, for example.

The configuration of display apparatus 150 is not limited to the above-described one. For example, the display apparatus may have functions such as control panel, switch and indicator for providing graphic display, and those functions of various monitors for managing the operating status of and operational directions for a control target apparatus or device, and terminals for input of a set value for the apparatus.

The screen data displayed on such a display apparatus may be created by a user by means of a screen data creation program. When the screen data creation program is executed on screen editor apparatus 100, a screen is displayed for editing. On the screen, the user can arbitrarily use an image block constituting display screen data used for displaying a status of each control target apparatus or control screen data used for receiving input of an instruction concerning control of each control target apparatus, for example, or can set whether or not operation is permitted. In the following description, the display screen data and the control screen data or the like are collectively referred to as monitor screen data. Here, the image block refers to, for example, an image such as the one constituting the monitor screen data by itself, an image (symbol) of a part such as lamp, switch, counter, meter indicator, graph indicator or the like displayed on the monitor screen data, or a supplementary image (such as popup window screen for example) displayed additionally to the monitor screen data or the image of the part. The image block, however is not limited to the above-described images. All of the images may be designed by the user or the images may be prepared as templates.

PLC 180 is connected to display apparatus 150 via network 190. PLC 180 is further connected to control target apparatuses 192, 194. PLC 180 operates as a control function unit to execute a control program set in advance and accordingly control the operation of control target apparatuses 192, 194. While control target apparatuses 192, 194 refer to for example automatic assembly machine, belt conveyor or the like, the control target apparatuses are not limited to them. Further, the number of control target apparatuses connected to PLC 180 is not limited to a specific number.

The screen data generated by screen editor apparatus 100 in the present embodiment is sent from communication I/F 116 to display apparatus 150.

Although screen editor apparatus 100 and display apparatus 150 are shown in the present embodiment as separate apparatuses, display apparatus 150 may be configured to function as screen editor apparatus 100 as well. In this case, communication line 130 is unnecessary.

[Functional Configuration]

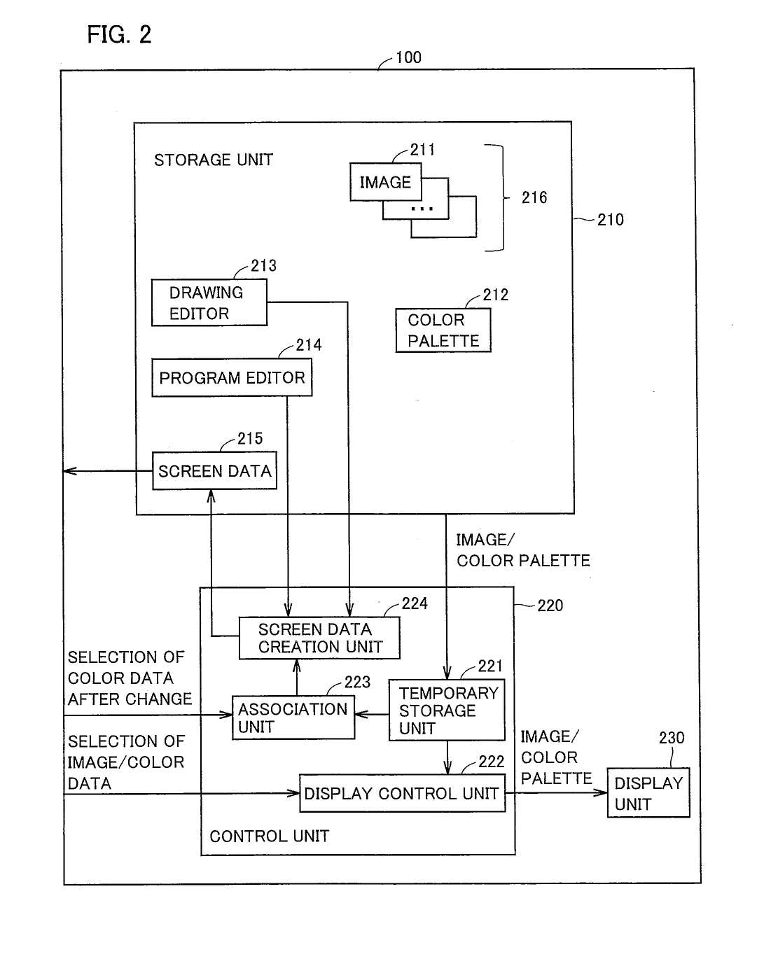

Referring to FIG. 2, a configuration of screen editor apparatus 100 will be further described. FIG. 2 is a block diagram showing the configuration of functions implemented by screen editor apparatus 100. Screen editor apparatus 100 includes a storage unit 210, a control unit 220 and a display unit 230.

Storage unit 210 stores a group of images 216 including a plurality of sample image data 211, a color palette (color data table) 212, a drawing editor 213, and a program editor 214. Further, storage unit 210 stores screen data 215 generated by control unit 220.

Sample image data 211 is prepared by the manufacturer of screen editor apparatus 100 as image data providing a part that constitutes screen data to be displayed on display apparatus 150. Color palette 212 shows a plurality of color data prepared by the manufacturer as candidates to which color data of the image is changed. The color data shown on color palette 212 can be selected by operating mouse 111 for example.

Drawing editor 213 is executed by CPU 110 to support editing of a screen displayed on display apparatus 150. Drawing editor 213 allows a user of screen editor apparatus 100 to change the color data of an image of a part with reference to sample image data 211 and color palette 212. Drawing editor 213 is created by the manufacturer of the screen editor apparatus as, for example, a program installed in advance, or a program product that can be installed from a data recording medium such as CD-ROM or the like.

Program editor 214 supports creation of a control program executed by display apparatus 150. Like drawing editor 213, program editor 214 supports creation of a program by a user of screen editor apparatus 100 with reference to sample image data 211 and color palette 212. It is unnecessary that screen editor apparatus 100 in the present embodiment always holds program editor 214. In other words, edit of a screen and edit of a control program may be performed by separate computer systems respectively.

Control unit 220 includes a temporary storage unit 221, a display control unit 222, an association unit 223, and a screen data creation unit 224, Temporary storage unit 221 holds, in a volatile manner, sample image data 211 and color palette 212 read from storage unit 210. Temporary storage unit 221 may also hold data generated by control unit 220.

Display control unit 222 causes, based on the selection provided to screen editor apparatus 100, and sample image data 211 and color palette 212 stored in temporary storage unit 221, display unit 230 to display an image based on the selected sample image data 211 and the selected palette.

Association unit 223 uses sample image data 211 and color palette 212 stored in temporary storage unit 221 to associate sample image data 211 with color data selected from color palette 212 (acquisition target color data, display color data described in detail hereinafter). Association unit 223 provides the image and color data to screen data creation unit 224.

Screen data creation unit 224 executes drawing editor 213 using the data sent from association unit 223 to create screen data. At this time, sample image data 211 and first color data are associated with each other to create a status indication image indicating a status of a control target apparatus. With the association maintained, screen data creation unit 224 creates screen data displayed on display 172. Screen data creation unit 224 sends the created screen data as screen data 215 to storage unit 210. In the case where a transmission cable is connected to screen editor apparatus 100, screen data creation unit 224 sends screen data 215 via the cable to the outside of screen editor apparatus 100. Alternatively, screen editor apparatus 100 may output screen data 215 via optical disc drive 115.

[Data Structure in Memory]

In the memory, an acquisition target color block, a control block and a display color block are stored. Each block is constituted of a data block.

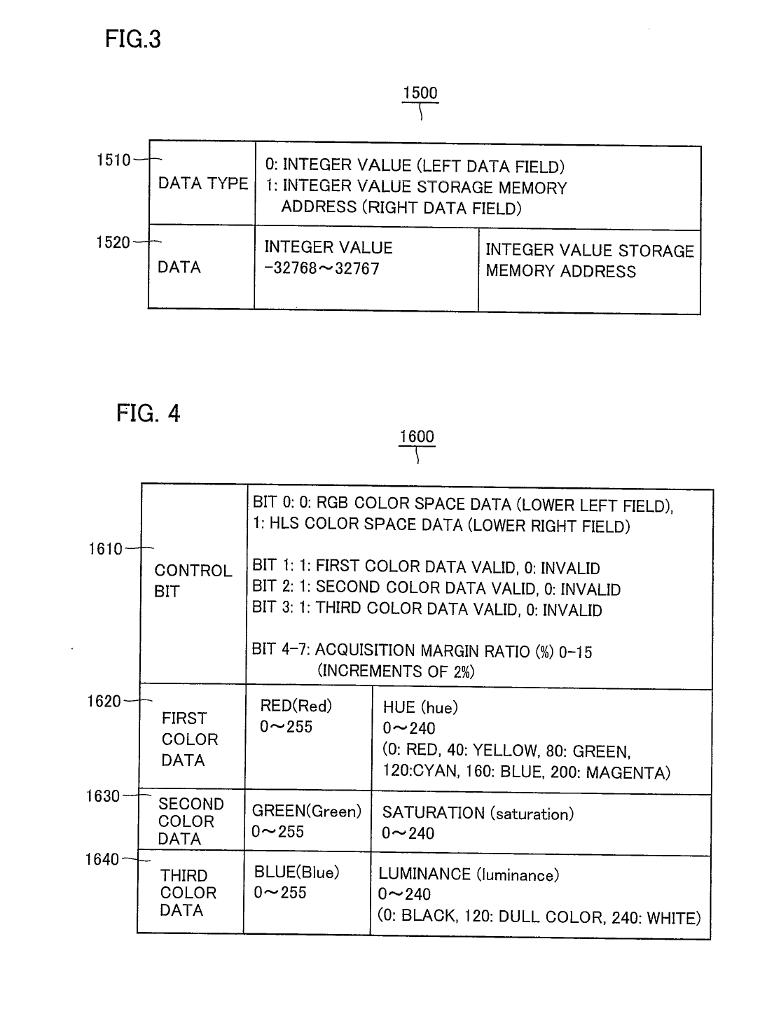

Referring first to FIG. 3, a structure of a data block will be described according to an embodiment. As shown in FIG. 3, data block 1500 includes data type 1510 and data 1520. Data type 1510 is represented by a value of 0 or 1. The value 0 represents that an integer value is stored in data 1520. The value 1 represents that an integer value storage memory address is stored in data 1520. In the case where data 1520 has an integer value, the value is from −32768 to 32767, for example. Other values may be used for the integer value.

In a particular case, however, where an upper limit and a lower limit of a range are defined as an available range of the integer value, the integer value may be any in the range defined by the upper limit and the lower limit. The integer value storage memory address indicates an address in the memory (memory address) such as D100 for example. In another particular case, a so-called device address may be used as the integer value storage memory address. “Device address” refers to an address associated with a specific device at the integer value storage memory address.

FIG. 4 shows a structure of an acquisition target color block 1600. “Acquisition” here means that color data, which is an attribute of a color, is specified by data or the like stored in the memory, and a pixel displayed with the color including the specified color data is designated in an image displayed on the screen. Acquisition target color block 1600 includes control bit 1610, first color data 1620, second color data 1630, and third color data 1640.

Control bit 1610 includes a bit representing whether each color data is RGB color space data or HLS color space data, a bit representing whether or not first color data is valid, a bit representing whether or not second color data is valid, a bit representing whether or not third color data is valid, and a bit for representing an acquisition margin ratio. The acquisition margin ratio will be described hereinafter.

When the 0-th bit is 0, it is defined that color data 1620, 1630, 1640 are RGB color space data. When the 0-th is 1, it is defined that color data 1620, 1630, 1640 are HLS color space data.

The first bit with the value 1 represents that first color data 1620 is valid, while the first bit with the value 0 represents that first color data 1620 is invalid. The second bit with the value 1 represents that second color data 1630 is valid, while the second bit with the value 0 represents that second color data 1630 is invalid. The third bit with the value 1 represents that third color data 1640 is valid, while the third bit with the value 0 represents that third color data 1640 is invalid.

The acquisition margin ratio is represented using the fourth bit to the seventh bit. Supposing that the rate of change of the acquisition margin ratio per bit is 2%, the acquisition margin ratio may be set from 0 to 30% in increments of 2%. If the fourth bit to the seventh bit are all set to 0, the acquisition margin ratio is also 0%. In this case, only the attribute of the color specified as an attribute to be acquired is detected. If the fourth bit to the seventh bit are all set to 1, the acquisition margin ratio is 30%.

If these bits set the value to 8, the acquisition margin ratio is defined as 16%. In this case, for each of color data 1620, 1630, 1640, “maximum value that can be set ±16%” of the data is allowed to be acquired. In this case, the maximum value to which “hue, saturation, luminance” is set is usually 240 at a personal computer using Windows (registered trademark) as the OS (Operating System). Accordingly, if the color data is “hue” and the value to which the hue is set is 120, for example, 16% of 240, namely 38 is applied to the range of acquisition and the range of acquisition is thus from “120−38” to “120+38”, namely from 82 to 158.

In the case where the color data is defined as RGB color space data, first color data 1620 defines a value of red. The value may be from 0 to 255 for example. In the case where the color data is defined as HLS color space data, the value of first color data 1620 defines hue and may have a value from 0 to 240. In this case, the color is red when the value of first color data 1620 is 0, the color is yellow when the value is 40, the color is green when the value is 80, the color is cyan when the value is 120, the color is blue when the value is 160, and the color is magenta when the value is 200.

In the case where the color data is defined as RGB color space data, second color data 1630 defines a value of green. The value may be from 0 to 255, for example. In the case where the data is defined as HLS color space data, second color data 1630 defines saturation and may have a value from 0 to 240.

In the case where the color data is defined as RGB color space data, third color data 1640 defines a value of blue. The value may be from 0 to 255, for example. In the case where the color data is defined as HLS color space data, third color data 1640 defines luminance and may have a value from 0 to 240. In this case, the color is black when the value of third color data 1640 is 0, the color is dull color when the value thereof is 120, and the color is white when the value thereof is 240, for example.

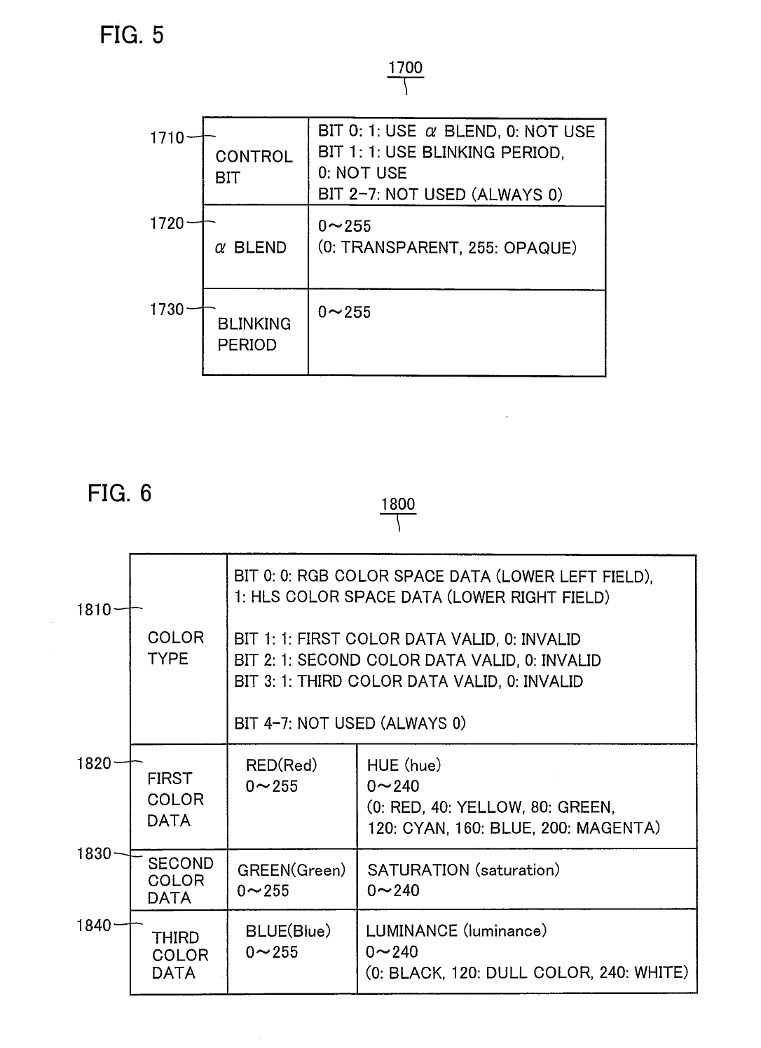

FIG. 5 conceptually illustrates a structure of a control block 1700. Control block 1700 includes control bit 1710, a blend 1720 and blinking period 1730.

Control bit 1710 defines how an image is to be displayed, such as whether or not α blend is used and whether or not blinking period is used. The 0-th bit of 1 represents that α blend is used. The 0-th bit of 0 represents that α blend is not used. The first bit of 1 represents that blinking period is used. The first bit of 0 represents that blinking period is not used. The second bit to the seventh bit are not used in the present embodiment and are always set to 0 for example.

α blend 1720 may take on a value from 0 to 255 in the present embodiment. In this case, the value 0 represents that display is transparent. The value 255 represents that display is opaque. Any value between 0 and 255 represents that display is provided according to the value (transmittance) such that display is transparent to allow an underlying screen to be seen.

Blinking period 1730 may take on a value from 0 to 255 in the present embodiment. The blinking period is set for example in increments of 10 milliseconds. Here, blinking period 1730 with the value 0 defines blinking at the highest rate that is possible for hardware constituting the display apparatus. By way of example, if blinking period 1730 is set to 200, the blinking period is 2000 milliseconds (namely 2 seconds), so that the image is displayed for 1 second and not displayed for 1 second.

Referring to FIG. 6, a display color block 1800 includes color type 1810, first color data 1820, second color data 1830, and third color data 1840.

The specific structure of display color block 1800 is similar to that of acquisition target color block 1600 except that the fourth to seventh bits of control bit 1810 are not used in the present embodiment and set to 0 for example. Therefore, the detailed description of the specific structure will not be repeated.

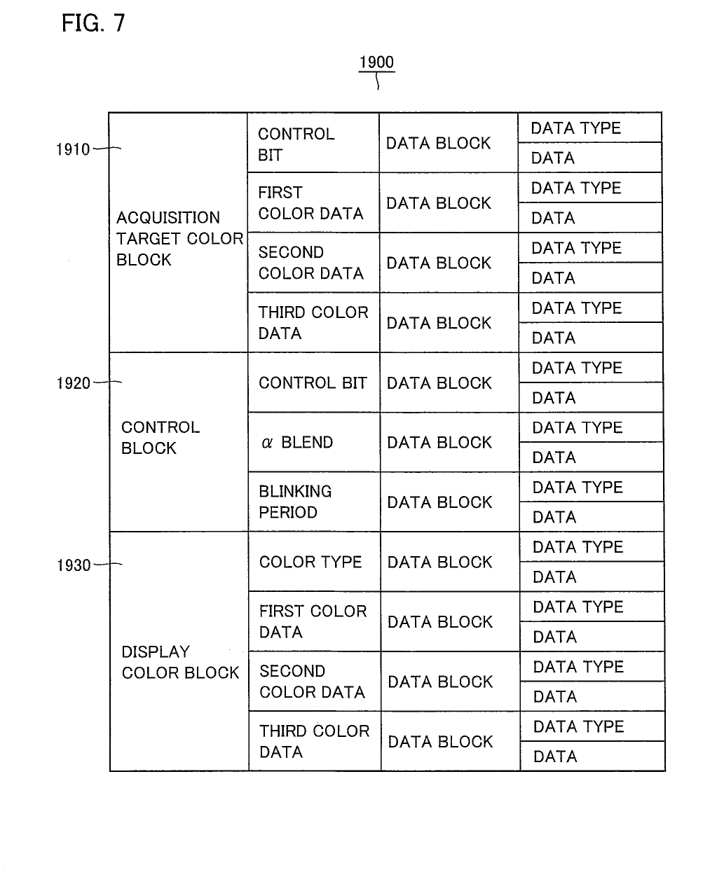

Referring to FIG. 7, a color attribute change control table 1900 according to the present embodiment is a collection of data for controlling change of a color attribute displayed on the screen. Color attribute change control table 1900 is used for changing an attribute of the color of an image displayed on the screen editor apparatus or display apparatus. Color attribute change control table 1900 includes an acquisition target color block 1910, a control block 1920 and a display color block 1930. An image refers to color attribute change control table 1900 and an image block associated with each other. In the image, a color attribute is changed as defined in color attribute change control table 1900.

Acquisition target color block 1910 includes control bit and first to third color data. The control bit includes a data block. The data block includes data type and data. Each color data includes a data block. The data block includes data type and data as shown in FIG. 3.

Control block 1920 includes control bit, α blend and blinking period. The control bit includes a data block. The data block includes data type and data. α blend includes a data block. The data block includes data type and data. The blinking period includes a data block. The data block includes data type and data.

Display color block 1930 includes color type and first to third color data. The color type and each color data each include a data block. The data block includes data type and data.

Color attribute change control table 1900 shown in FIG. 7 is implemented using respective data structures shown in FIGS. 3 to 6.

[Exemplary Display]

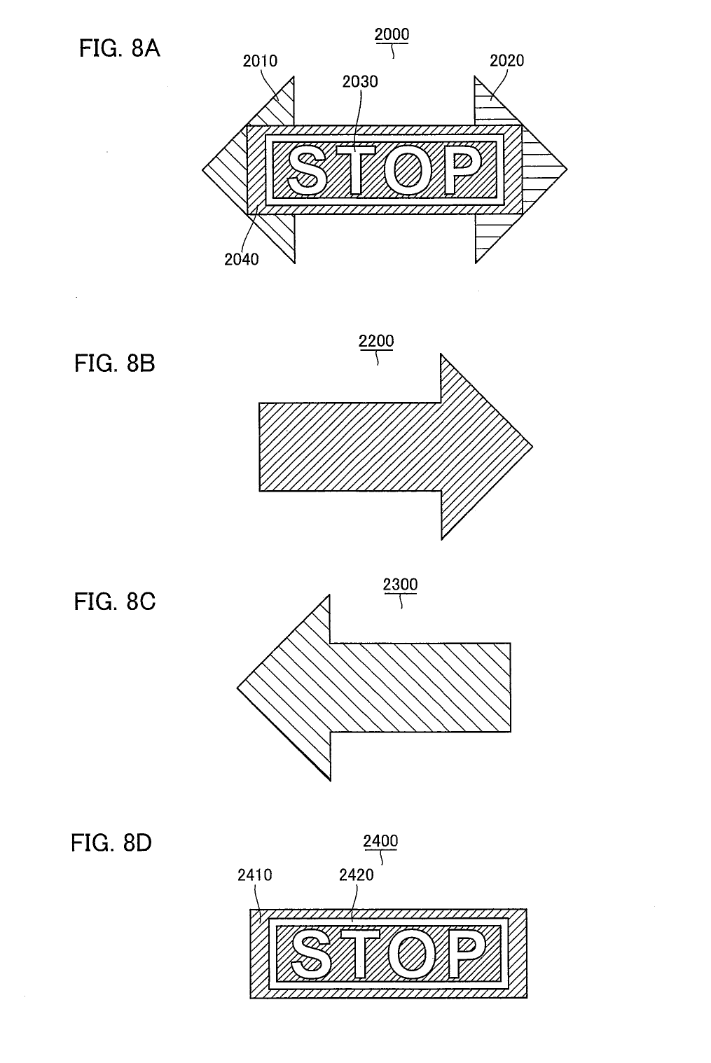

Referring to FIGS. 8A to 8D, a description will be given of a manner in which an image is displayed on the display apparatus according to the present embodiment. FIG. 8A shows an entire image 2000 displayed by the display apparatus. Image 2000 includes regions 2010, 2020, characters 2030 and a background 2040. Regions 2010 and 2020 are in the shape of a triangle defined in advance. Characters 2030 are produced for display on the display apparatus using characters created by a user of the screen editor apparatus or using data prepared by the manufacturer of the screen editor apparatus. Background 2040 is set in advance in the form of a template by a user of the screen editor apparatus or the manufacturer of the screen editor apparatus. In the following description, it is supposed that region 2010 is blue, region 2020 is green and background 2040 is red. The color of characters 2030 may be changed according to a data value as described hereinafter.

FIG. 8B illustrates display of an image 2200 representing a right-pointing arrow generated from image 2000 set in advance. Specifically, in the case where data is set in the color attribute change control table in the manner as described below, image 2200 shown in FIG. 8B is achieved. More specifically, in the case where the value of integer value storage memory address D100 is 0, display of region 2010 is transparent. Then, in the case where respective values of integer value storage memory addresses D200 to D203 are set to 255, 255, 0, 0, respectively, region 2020 is displayed in red. Further, in the case where respective values of integer value storage memory addresses D300 to D303 are set to 255, 255, 0, 0, respectively, characters 2030 are displayed in red. Here, since the initial value of background 2040 is set to red, the region of characters 2030 and the region of background 2040 are both displayed in red. In this way, image 2200 representing a right-pointing arrow is displayed as shown in FIG. 8B.

FIG. 8C illustrates an image 2300 representing a left-pointing arrow. Image 2300 is displayed by performing the following process on the display of image 2000. Specifically, in the color attribute change control table described hereinafter, respective values of integer value storage memory addresses D100 to D103 for display of region 2010 are set to 255, 255, 0, 0, respectively. Thus, region 2010 is displayed in red. Then, respective values of integer value storage memory addresses D200 to D203 for display of region 2020 are set to 0, 0, 0, 0, respectively. Accordingly, display of region 2020 is transparent, so that this region is invisible.

Further, respective values of integer value storage memory addresses D300 to D303 for controlling display of characters 2030 are set to 255, 255, 0, 0, respectively. Thus, characters 2030 are displayed in red which is the same as the color of background 2040 set to red by default. Accordingly, the region including characters 2030 and background 2040 is entirely displayed uniformly in red.

FIG. 8D illustrates an image 2400 representing the character portion without triangular portions as compared with image 2000. Image 2400 includes a region 2410 showing the background and a region 2420 for showing characters to be displayed. Image 2400 is displayed by setting data in the following manner. Specifically, respective values of integer value storage memory addresses D100 to D103 for controlling display of region 2010 provided for displaying a left-pointing arrow are all set to 0. Thus, display of region 2010 is transparent. Similarly, respective values of integer value storage memory addresses D200 to D203 for controlling display of region 2020 provided for displaying a right-pointing arrow are all set to 0. Thus, display of region 2020 is also transparent. Then, respective values of integer value storage memory addresses D300 to D303 for controlling display of characters 2030 are set to 255, 255, 255, 0, respectively. According to these settings, characters 2030 are displayed in yellow. Since background 2410 is displayed in the same color (red) as the color of background 2040 in FIG. 8A, the character portion is displayed in yellow as shown in FIG. 8D.

[Data Structure of Display Apparatus]

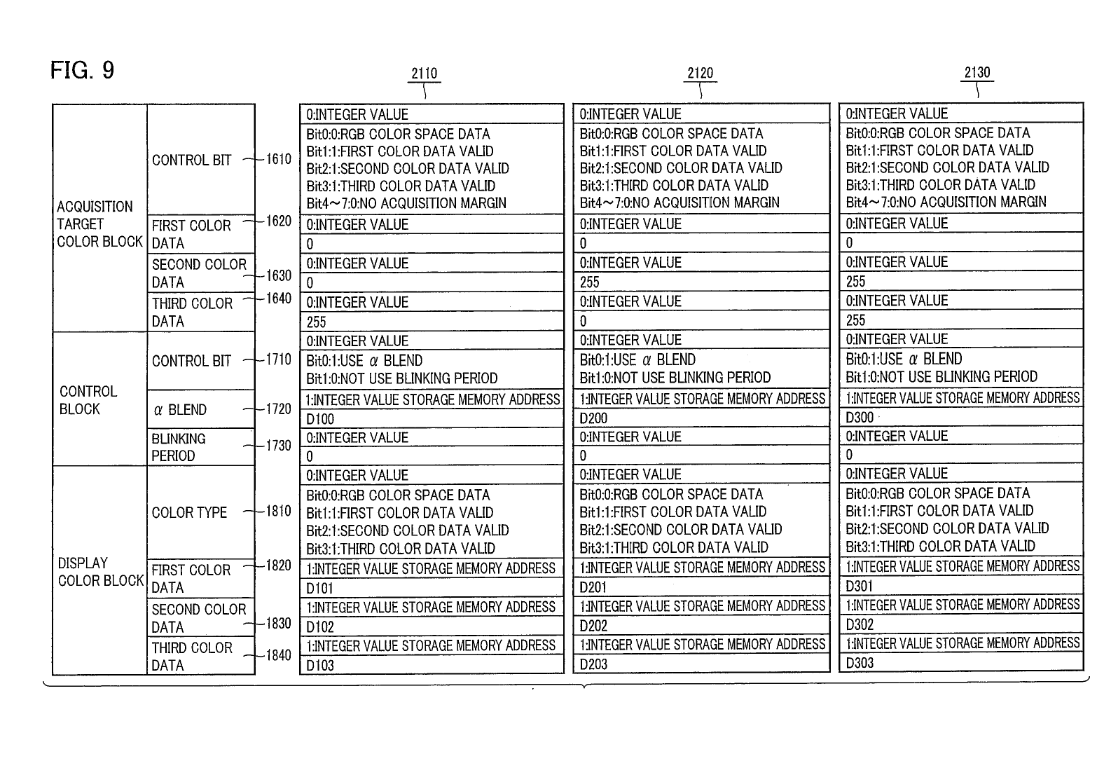

Referring to FIG. 9, a description will be given of a data structure of the display apparatus according to the present embodiment. FIG. 9 conceptually shows respective structures of color attribute change control tables 2110, 2120, 2130 stored in the memory of the display apparatus. Tables 2110, 2120, 2130 are each produced following the format for color attribute change control table 1900 shown in FIG. 7.

Table 2110 defines that blue (third color data 255) is acquired and the color is changed to the color specified by integer value storage memory addresses D100 to D103. Table 2120 defines that green (second color data 255) is acquired from the displayed image and the color is changed to the color specified by integer value storage memory addresses D200 to D203. Table 2130 defines that cyan (second and third color data 255) is acquired from the displayed image and the color is changed to the color specified by integer value storage memory addresses D300 to D303.

Respective set values shown in tables 2110 to 2130 are identical to those in respective data structures of the tables shown in FIGS. 3 to 7 as described above. Thus, the detailed description of each set value will not be repeated.

[Control Structure]

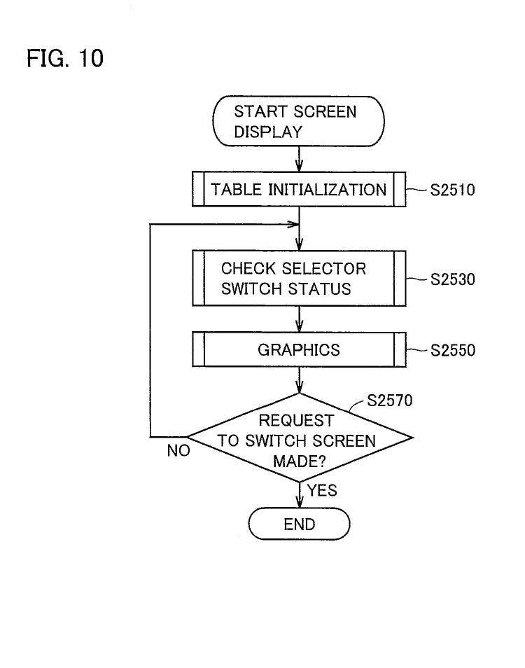

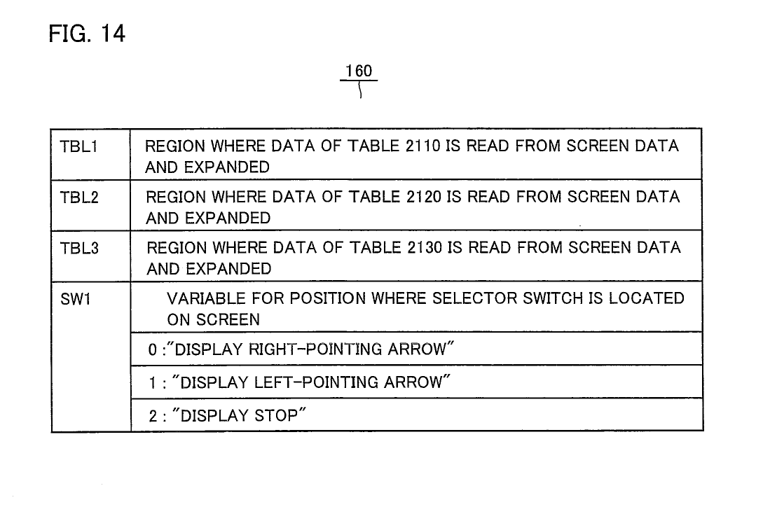

Referring to FIGS. 10 to 14. a description will be given of a control structure of the display apparatus according to the present embodiment. FIGS. 10 to 14 are each a flowchart illustrating a part of a series of processes executed by CPU 152 for implementing the display shown in FIGS. 8B to 8D. FIG. 14 conceptually shows a manner in which data is stored in VRAM 168.

(Main Flow)

As shown in FIG. 10, in step S2510, CPU 152 performs table initialization as described hereinafter. This step is executed and data stored in each table is written in a work region of the memory. In step S2530, CPU 152 checks the status of a selector switch as described hereinafter. This step is executed and how an image should be displayed on the display apparatus is specified. A detailed description of how an image is displayed according to the status of the selector switch will be given hereinafter. In step S2550, CPU 152 executes a graphics process as described hereinafter. This step is executed and a specific image is shown on the display apparatus.

In step S2570, CPU 152 determines whether or not a request to switch a screen is made. The determination is made for example based on data provided to the display apparatus (signal from a control target apparatus or given from an operator of the display apparatus). When CPU 152 determines that a request to switch a screen is made (YES in step S2570), CPU 152 ends this control. Otherwise (NO in step S2570), CPU 152 returns to step S2530.

(Table Initialization)

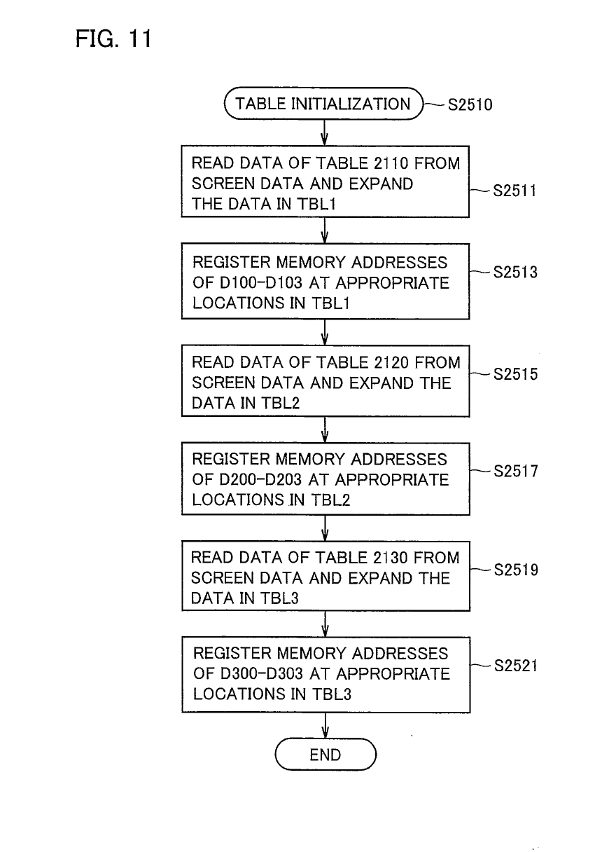

FIG. 11 illustrates a detailed flow of step S2510 in FIG. 10. In step S2511, CPU 152 reads data of table 2110 from the screen data and expands the read data in a work region TBL 1. In step S2513, CPU 152 registers respective values of integer value storage memory addresses D100 to D103 at appropriate locations in region TBL 1.

In step S2515, CPU 152 reads data of table 2120 from the screen data and expands the read data in a region TBL 2. In step S2517, CPU 152 registers respective values of integer value storage memory addresses D200 to D203 at appropriate locations in region TBL 2. In step S2519, CPU 152 reads data of table 2130 from the screen data and expands the read data in a region TBL 3. In step S2521, CPU 152 registers respective values of integer value storage memory addresses D300 to D303 at appropriate locations in region TBL 3.

(Checking of Selector Switch Status)

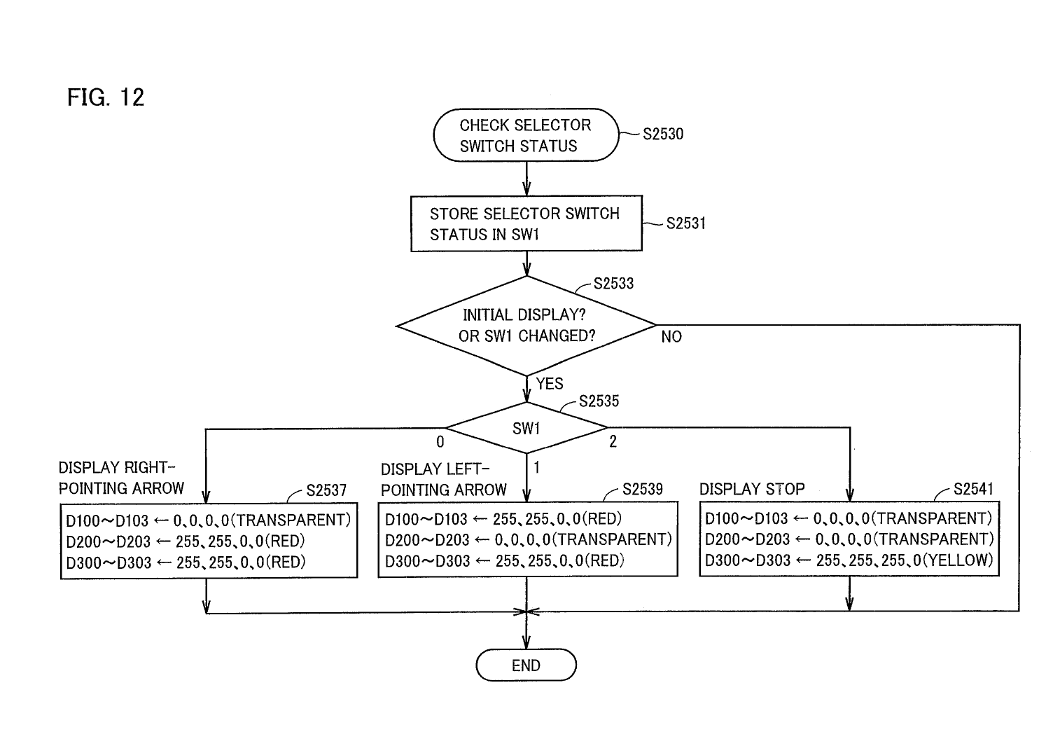

FIG. 12 illustrates a detailed flow of step S2530 in FIG. 10. In step S2531, CPU 152 stores data indicating the status of a selector switch in a region SW 1 of memory 160. In step S2533, CPU 152 determines whether or not the display of the display apparatus is initial display, or whether or not the data stored in SW 1 is changed, based on the data stored in region SW 1. When CPU 152 determines that the display apparatus shows the initial display, or that the data stored in region SW 1 is changed (YES in step S2533), CPU 152 proceeds to step S2535. Otherwise (NO in step S2533), CPU 152 ends the process and displays the image shown in FIG. 8.

In step S2535, CPU 152 specifies an image to be displayed by the display apparatus, based on the data stored in region SW 1. Specifically, CPU 152 specifies which of respective images shown in FIGS. 5B to 5D is to be displayed. When the data stored in region SW 1 is 0, CPU 152 proceeds to step S2537. When the value of the data is 1, CPU 152 proceeds to step S2539. When the value of the data is 2, CPU 152 proceeds to step S2541.

In step S2537, CPU 152 sets data for displaying a right-pointing arrow. Specifically, in order to make region 2010 transparent, CPU 152 sets respective values of integer value storage memory address D100 to D103 to 0. In order to display region 2040 in red, CPU 152 sets respective values of integer value storage memory addresses D200 to D203 to 255, 255, 0, 0, respectively. In order to display region 2020 in red, CPU 152 sets respective values of integer value storage memory addresses D300 to D303 to 255, 255, 0, 0, respectively.

In step S2539, CPU 152 sets data in the memory region for displaying a left-pointing arrow. Specifically, in order to provide display in red, CPU 152 sets respective values of integer value storage memory addresses D100 to D103 to 255, 255, 0, 0, respectively. In order to make display transparent, CPU 152 sets respective values of integer value storage memory addresses D200 to D203 to 0, 0, 0, 0, respectively. In order to provide display in red, CPU 152 sets respective values of integer value storage memory addresses D300 to D303 to 255, 255, 0, 0, respectively.

In step S2541, CPU 152 sets data in the memory for displaying characters “STOP.” Specifically, CPU 152 sets respective values of integer value storage memory addresses D100 to D103 to 0, 0, 0, 0, respectively. Accordingly, the display of the corresponding region is transparent. CPU 152 sets respective values of integer value storage memory addresses D200 to D203 to 0, 0, 0, 0, respectively. Accordingly, the display of the corresponding region is transparent. Further, CPU 152 sets respective values of integer value storage memory addresses D300 to D303 to 255, 255, 255, 0, respectively. Accordingly, the display of the corresponding region is yellow.

(Graphics Process)

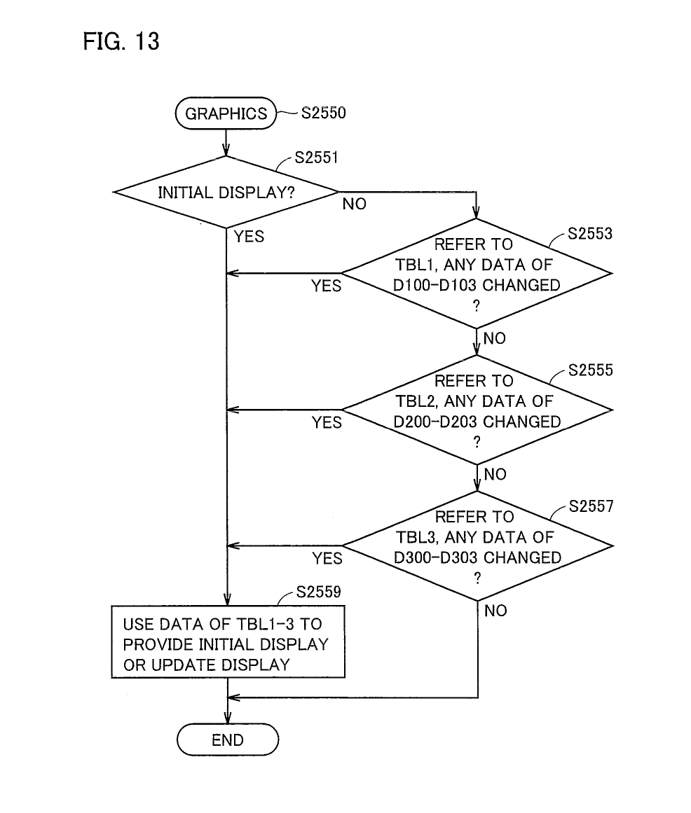

Referring to FIG. 13, in step S2551, CPU 152 determines whether or not the status of the display apparatus is initial display. The determination is made for example based on a value that is stored in memory 160 for indicating the status of display apparatus 150. When CPU 152 determines that the status of display apparatus 150 is initial display (YES in step S2551), CPU 152 proceeds to step S2559. Otherwise (NO in step S2551), CPU 152 proceeds to step S2553.

In step S2553, CPU 152 refers to region TBL 1 to determine whether or not any of the data of integer value storage memory addresses D100 to D103 is changed. When CPU 152 determines that any of the data is changed (YES in step S2553), CPU 152 proceeds to step S2559. Otherwise (NO in step S2553), CPU 152 proceeds to step S2555.

In step S2555, CPU 152 refers to TBL 2 to determine whether or not any of the data of integer value storage memory addresses D200 to D203 is changed. When CPU 152 determines any of the data is changed (YES in step S2555), CPU 152 proceeds to step S2559. Otherwise (NO in step S2555), CPU 152 proceeds to step S2557.

In step S2557, CPU 152 refers to region TBL 3 to determine whether or not any of the data of integer value storage memory addresses D300 to D303 is changed. When CPU 152 determines that any of the data is changed (YES in step S2557), CPU 152 proceeds to step S2559. Otherwise (NO in step S2557), CPU 152 ends the process.

(Data Structure)

Referring to FIG. 14, VRAM 168 includes a plurality of regions secured for displaying an image on display 172. Region TBL 1 is used for expanding data included in table 2110 read from the screen data. Region TBL 2 is used for expanding data included in table 2120 read from the screen data. Region TBL 3 is used for expanding data included in table 2130 read from the screen data. Region SW 1 stores a variable for indicating the position of a selector switch disposed on the screen displayed on display 172. For example, when the value of the variable is 0, a right-pointing arrow is displayed. When the value is 1, a left-pointing arrow is displayed. When the value is 2, characters STOP are displayed.

In this way, display apparatus 150 of the present embodiment can display images in different manners using the image structured as shown in FIG. 8A.

### Second Embodiment

A second embodiment will now be described. A display apparatus and a screen editor apparatus in the present embodiment differ from the display apparatus and the screen editor apparatus in the above-described embodiment in that the former have the capability of expressing motion by changing the displayed color. The display apparatus and the screen editor apparatus in the second embodiment are implemented using a hardware configuration similar to the hardware configuration for implementing display apparatus 150 and screen editor apparatus 100 in the above-described embodiment. Therefore, the description of the hardware configuration will not be repeated. The following description will be given with reference to the configuration shown in FIG. 1.

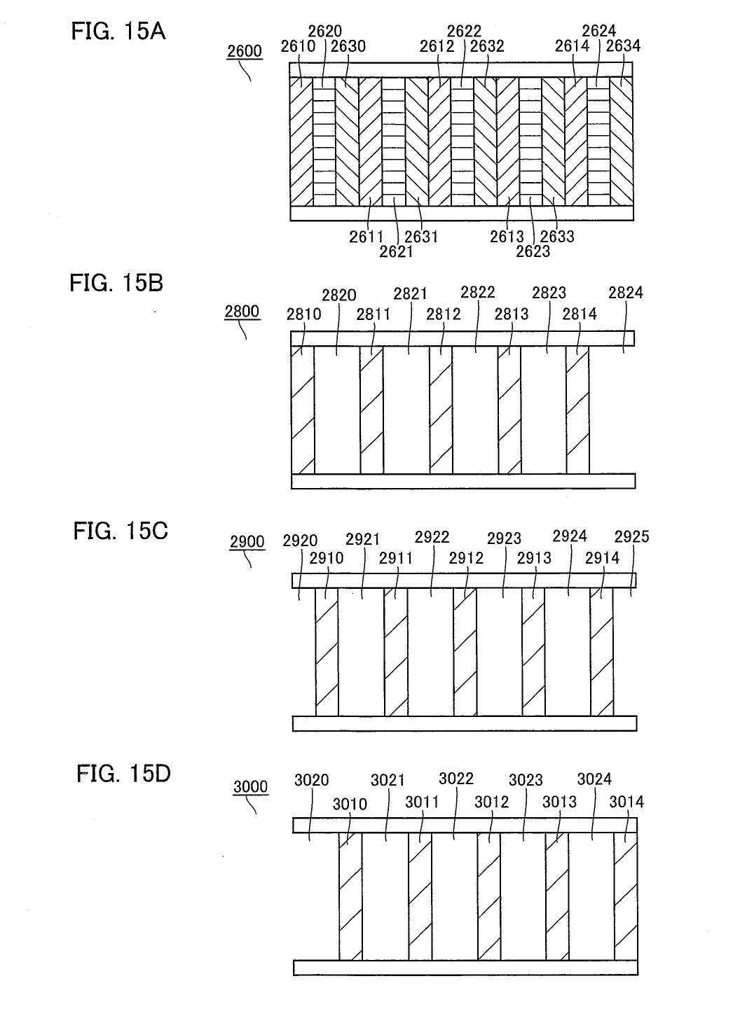

FIG. 15A shows an image 2600 displayed on the display apparatus. Image 2600 includes regions 2610-2614, 2620-2624, 2630-2634. In the present embodiment, region 2610-2614, region 2620-2624 and region 2630-2634 are each displayed in the same color. Image 2600 and each region are defined by the screen editor apparatus in the present embodiment, for example.

In the example shown in FIG. 15A, regions 2610, 2611, 2612, 2613, 2614 are red, regions 2620, 2621, 2622, 2623, 2624 are green, and regions 2630, 2631, 2632, 2633, 2634 are blue.

FIGS. 15B to 15D show a manner in which image 2600 is used to display the image partially in cyan and partially in white. As shown in FIG. 15B, image 2800 includes region 2810-2814 (regions 2810, 2811, 2812, 2813, 2814), and region 2820-2824 (regions 2820, 2821, 2822, 2823, 2824). Region 2810-2814 is displayed in cyan, and region 2820-2824 is displayed in white. Such display is implemented in the case where data is defined in tables 2710, 2720, 2730 as follows. Specifically, in table 2710, when the value referenced by integer value storage memory address D100 is 0, the red acquired from the image shown on the display apparatus is changed to cyan. In table 2720, when the value referenced by integer value storage memory address D200 is 255, the green acquired from image 2600 shown on the display apparatus (regions 2620, 2621, 2622, 2623, 2624 for example) is changed to white. In table 2730, when the value referenced by integer value storage memory address D300 is set to 255, the green acquired from image 2600 (regions 2630-2634 (2630, 2631, 2632, 2633, 2634) for example) is changed to white.

FIG. 15C illustrates a state where the position of the green region in image 2800 is changed. Image 2900 includes region 2910-2914 (regions 2910, 2911, 2912, 2913, 2914), and region 2920-2925 (regions 2920, 2921, 2922, 2923, 2924, 2925). Region 2910-2914 is displayed in cyan. Region 2920-2925 is displayed in white. Such display is implemented by defining data as follows in tables 2710, 2720, 2730.

Specifically, in table 2720, the value referenced by integer value storage memory address D200 is set to 0. When CPU 152 reads this value, the green acquired from the displayed image is changed to cyan.

The value referenced by integer value storage memory address D100 in table 2710 and the value referenced by integer value storage memory address D300 in table 2730 are both set to 255. CPU 152 reads the values and changes the regions displayed in red and blue to white. Accordingly, as shown in FIG. 14, cyan region 2910-2914 and white region 2920-2925 are displayed.

FIG. 15D illustrates another manner in which display is provided partially in white and partially in cyan, based on image 2600 shown in FIG. 15A. An image 3000 includes region 3010-3014 (regions 3010, 3011, 3012, 3013, 3014) and region 3020-3024 (regions 3020, 3021, 3022, 3023, 3024). Region 3010-3014 is displayed in cyan. Region 3020-3024 is displayed in white. Such display is implemented by defining data in tables 2710, 2720, 2730 as follows.

Specifically, the value referenced by integer value storage memory address D100 in table 2710 and the value referenced by integer value storage memory address D200 in table 2720 are both set to 255. In table 2730, the value referenced by integer value storage memory address D300 is set to 0. Under these settings, CPU 152 acquires red or green from the image displayed on the display apparatus and changes the regions to white. Further, CPU 152 acquires blue from the image and changes the color of the blue portion to white.

CPU 152 repeats the graphics process based on the settings as described above to successively display any of images 2800 to 3000 (images 2800, 2900, 3000) including white and cyan, using image 2600 prepared by default. In this way, display apparatus 150 can implement display such as the one where water appears to flow rightward in a pipe on display 172. On the contrary, CPU 152 may switch the display using image 2600 in the order of image 3000, image 2900, and image 2800, for example, so that the display can be implemented where water appears to flow from right toward left in the pipe. Thus, display apparatus 150 in the present embodiment can implement motion by changing colors based on one image 2600 set in advance.

(Data Structure)

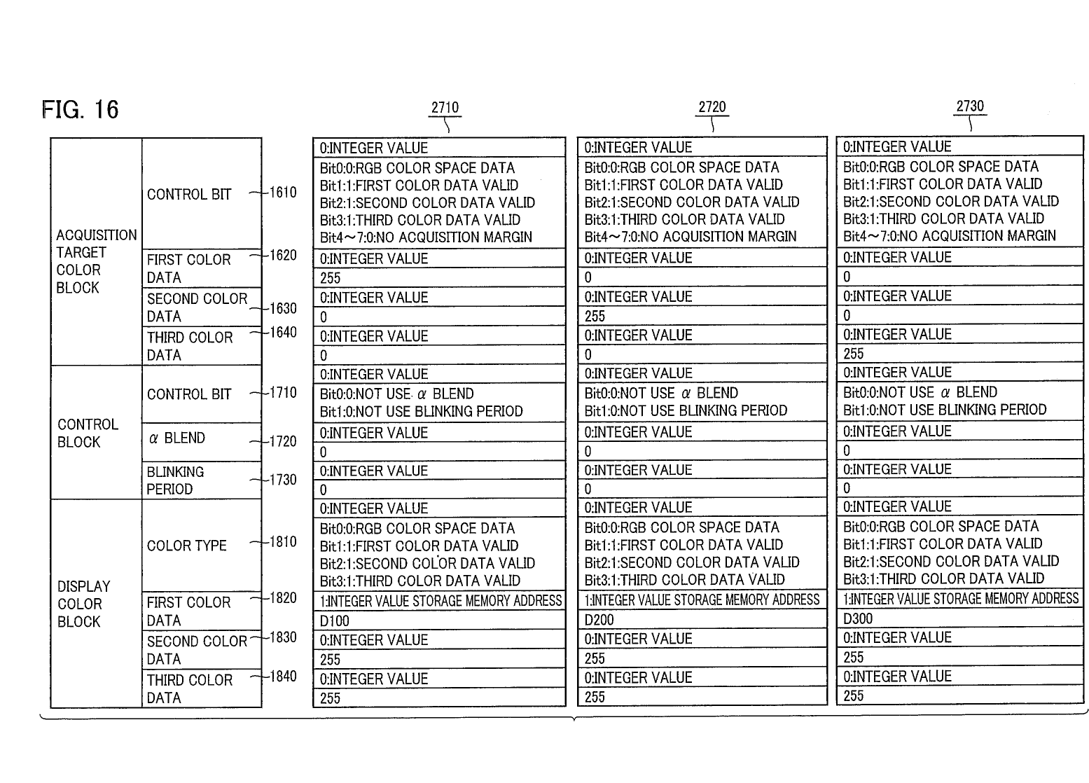

Referring to FIG. 16, a description will be given of a data structure of the display apparatus according to the present embodiment. FIG. 16 schematically shows a structure of each table stored by the display apparatus. These tables are defined by the screen editor apparatus for example and taken into the display apparatus as data referenced directly or indirectly by an executable program. The format of each table is similar to the table format shown in FIG. 9.

Table 2710 defines data for acquiring red from an image displayed on the display apparatus and changing the color to a color specified by integer value storage memory address D100. Table 2720 stores data for acquiring green from an image displayed on the display apparatus and changing the color to a color specified by integer value storage memory address D200. Table 2730 defines data for acquiring blue from an image displayed on the display apparatus and changing the color to a color specified by integer value storage memory address D300.

Tables 2710, 2720, 2730 are produced based on the data defined in FIGS. 4 to 7. Since the data items constituting each table are similar to the data items shown in these drawings, and the description will not be repeated.

[Control Structure]

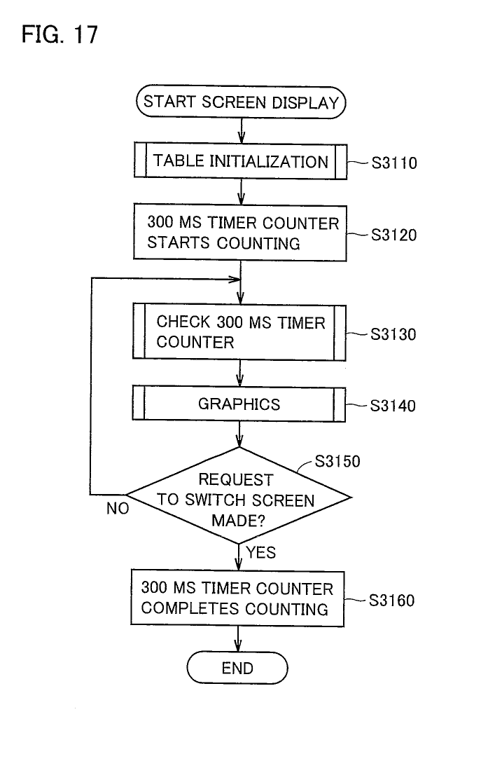

Referring to FIGS. 17-21, a description will be given of a control structure of the display apparatus according to the present embodiment.

(Main Flow)

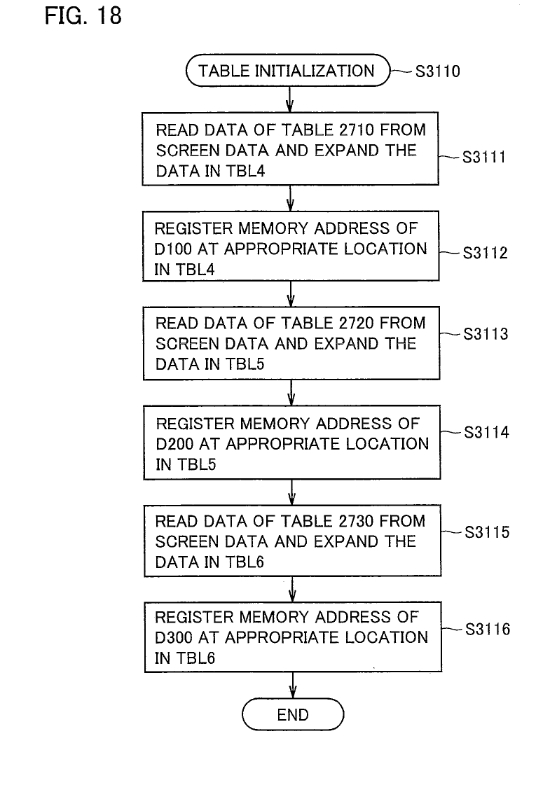

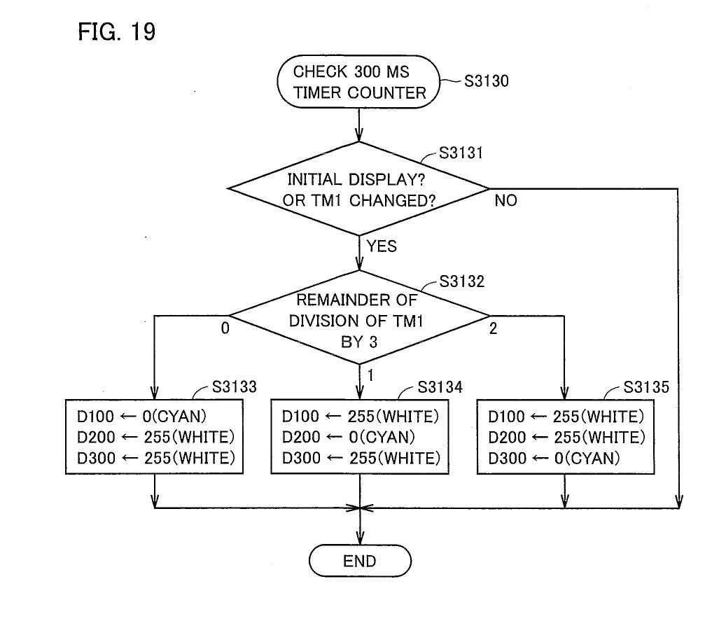

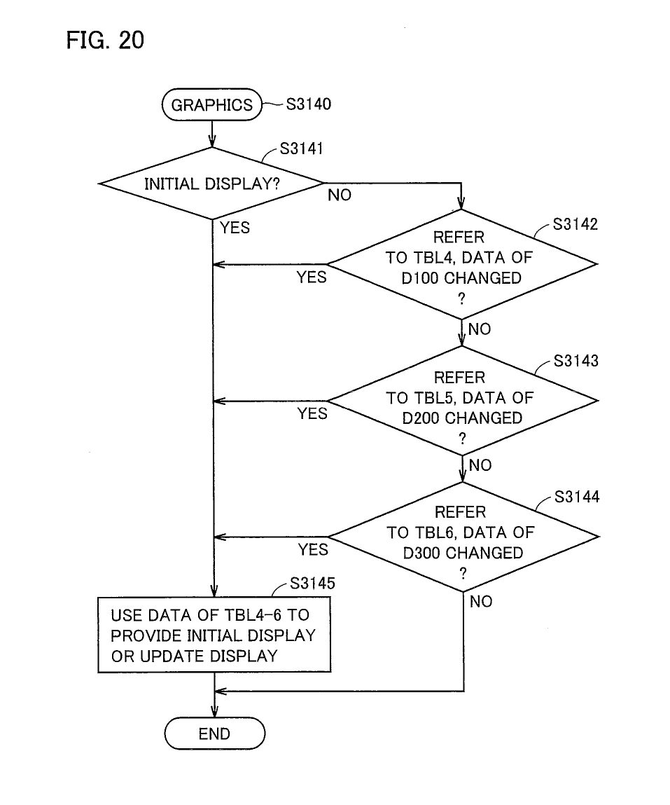

As shown in FIG. 17, in step S3110, CPU 152 executes table initialization as described hereinafter (FIG. 18). This step is executed and data included in a table read from an image object is expanded in each work region of DRAM 162. In step S3120, CPU 152 activates a counter function to start counting 300 milliseconds, for example. In step S3130, CPU 152 checks the status of the counter as described hereinafter (FIG. 19). This step is executed and the color of an image to be displayed on display 172 is determined. In step S3140, CPU 152 executes a graphics process as described hereinafter (FIG. 20). This step is executed and display 172 accordingly displays a specific image.

In step S3150, CPU 152 determines whether or not a request to switch a screen displayed on display 172 is made, based on a signal provided to display apparatus 150. When CPU 152 determines that such a request is made (YES in step S3150), CPU 152 proceeds to step S3160. Otherwise (NO in step S3150), CPU 152 returns to step S3130. In step S3160, CPU 152 completes the activated counter function and completes counting of 300 milliseconds.

(Table Initialization)

As shown in FIG. 18, in step S3111, CPU 152 reads data of table 2710 from screen data, and expands the read data in a memory region TBL 4 of VRAM 168. In step S3112, CPU 152 registers the value of integer value storage memory address D100 at an appropriate location in memory region TBL 4.

In step S3113, CPU 152 reads data of table 2720 from the screen data, and expands the read data in a memory region TBL 5. In step S3114, CPU 152 registers the value of integer value storage memory address D200 at an appropriate location in memory region TBL 5

In step S3115, CPU 152 reads data of table 2730 from the screen data, and expands the read data in a memory region TBL 6. In step S3116, CPU 152 registers the value of integer value storage memory address D300 at an appropriate location in memory region TBL 6.

(Checking of Counter)

Referring to FIG. 19, in step S3131, CPU 152 determines whether or not the screen of display 172 is showing initial display or whether or not the counter value is changed, based on a value stored in memory 160 or the count value. When CPU 152 determines that display 172 is in an initial display state or that counter value TM1 is changed (YES in step S3131), CPU 152 proceeds to step S3132. Otherwise (NO in step S3131), CPU 152 ends the process.

In step S3132, CPU 152 determines the remainder of the division of counter value TM1 by 3. When the remainder is 0, CPU 152 proceeds to step S3133. When the remainder is 1, CPU 152 proceeds to step S3134. When the remainder is 2, CPU 152 proceeds to step S3135.

In step S3133, CPU 152 sets the value of integer value storage memory address D100 to 0. Accordingly, the associated region is displayed in cyan. CPU 152 sets respective values of integer value storage memory addresses D200 and D300 to 255, 255. Accordingly, the associated region is displayed in white.

In step S3134, CPU 152 sets respective values of integer value storage memory addresses D100 and D300 to 255, 255. The associated region is accordingly displayed in white. Further, CPU 152 sets the value of integer value storage memory address D200 to 0. The associated region is accordingly displayed in cyan.

In step S3135, CPU 152 sets respective values of integer value storage memory addresses D100 and D200 to 255, 255. Accordingly, the associated region is displayed in white. CPU 152 sets the value of integer value storage memory address D300 to 0. The associated region is accordingly displayed in cyan.

(Graphics Process)

Referring to FIG. 20, in step S3141, CPU 152 determines whether or not the state of display 172 is initial display. When CPU 152 determines that the state is initial display (YES in step S3141), CPU 152 proceeds to step S3145. Otherwise (NO in step S3141), CPU 152 proceeds to step S3142.

In step S3142, CPU 152 refers to memory region TBL 4 to determine whether or not the data of integer value storage memory address D100 is changed. When CPU 152 determines that the data is changed (YES in step S3142), CPU 152 proceeds to step S3145. Otherwise (NO in step S3142), CPU 152 proceeds to step S3143.

In step S3143, CPU 152 refers to memory region TBL 5 to determine whether or not the data of integer value storage memory address D200 is changed. When CPU 152 determines that the data is changed (YES in step S3143), CPU 152 proceeds to step S3145. Otherwise (NO in step S3143), CPU 152 proceeds to step S3144.

In step S3144, CPU 152 refers to memory region TBL 6 to determine whether or not the data of integer value storage memory address D300 is changed. When CPU 152 determines that the data is changed (YES in step S3144), CPU 152 proceeds to step S3145. Otherwise (NO in step S3144), CPU 152 ends the process.

(Data Structure)

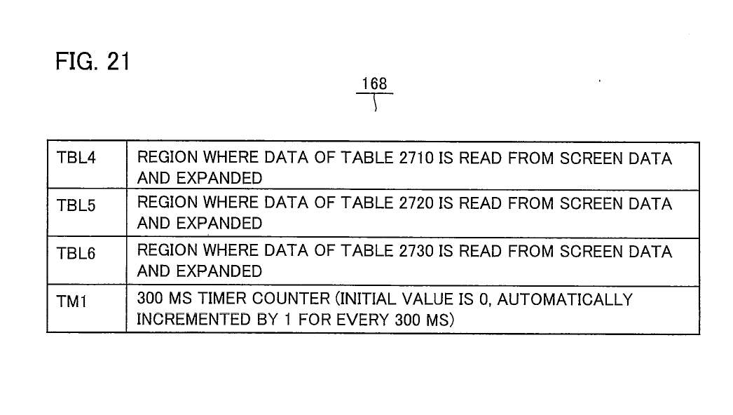

Referring to FIG. 21, VRAM 168 secures regions where data for displaying the images as shown in FIGS. 15B to 15D is stored. Memory region TBL 4 is used for expanding the data included in table 2710 read from screen data. Memory region TBL 5 is used for expanding the data included in table 2720 read from the screen data. Memory region TBL 6 is used for expanding the data included in table 2730 read from the screen data. Memory region TM1 is used as a counter. Specifically, the initial value is set to 0, which is incremented by one each time 300 milliseconds have elapsed.

### Third Embodiment

A third embodiment will now be described. A display apparatus and a screen editor apparatus in the present embodiment are implemented using a hardware configuration similar to the hardware configuration for implementing display apparatus 150 and screen editor apparatus 100 in the above-described embodiment. Therefore, the description of the hardware configuration will not be repeated. The following description will be given with reference to the configuration shown in FIG. 1.

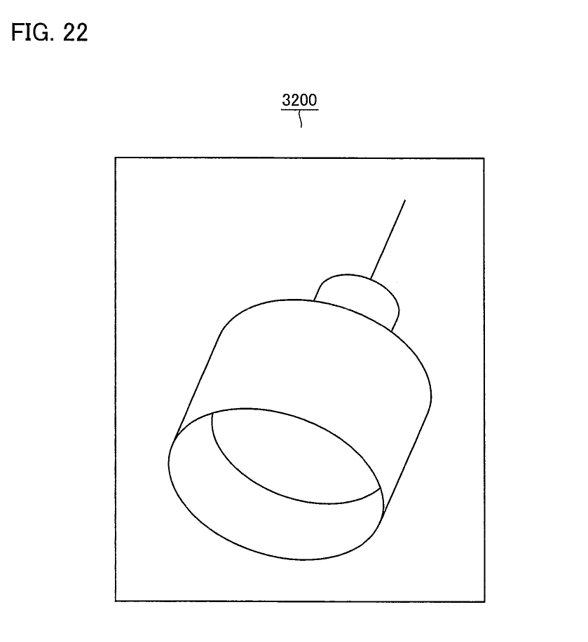

FIG. 22 illustrates an image 3200 prepared for displaying the image on display 172 by display apparatus 150. Image 3200 shows a lamp as an example, and is not limited to this.

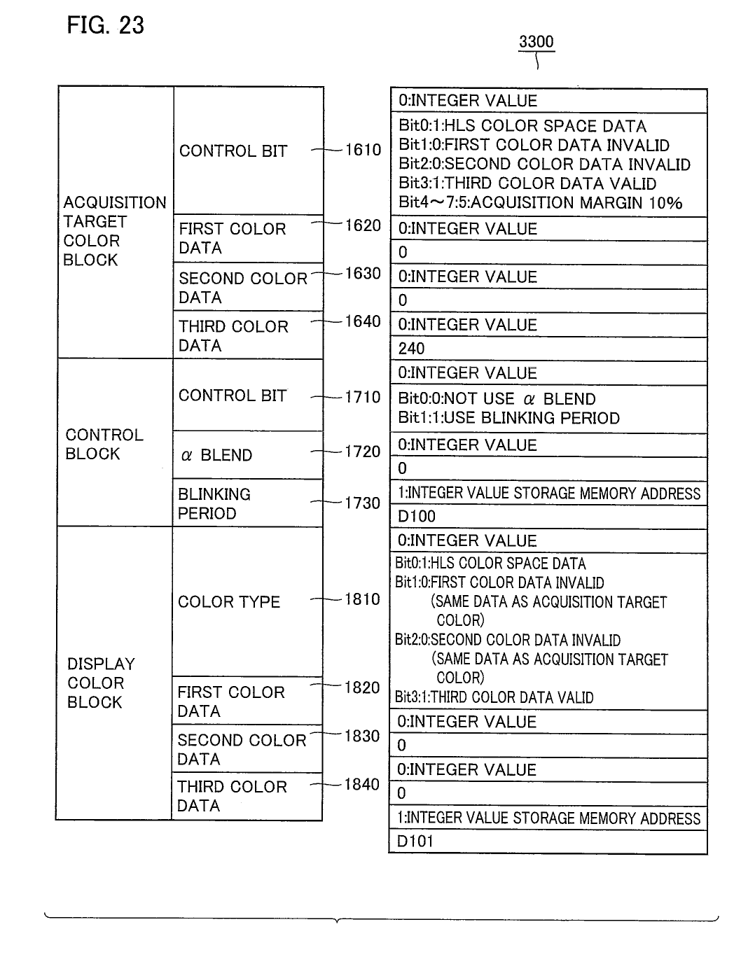

Referring to FIG. 23, a description will be given of a data structure of the display apparatus according to the present embodiment. FIG. 23 schematically illustrates a structure of a table 3300 stored in memory 160 by the display apparatus in the present embodiment. The format of each table is similar to the table format shown in FIG. 9.

Table 3300 includes an acquisition target color block, a control block and a display color block. The data items constituting table 3300 are similar to corresponding items included in the tables shown in FIGS. 4 to 6, respectively. Therefore, the detailed description of each item will not be repeated. Table 3300 is defined for acquiring a substantially white portion (luminance 216-240 for example) from a portion associated with table 3300 in the image displayed on display 172, and changing the image according to the blinking period specified by integer value storage memory address D100 and the luminance specified by integer value storage memory address D101. Regarding the control bit in the acquisition target color block, value 5 is defined by the fourth to the seventh bits. Namely, the margin of acquisition is defined as 10%. This is for the reason that, if an image displayed by display apparatus 150 has a photograph image quality, respective colors of the pixels are slightly different from each other, and thus some margin is necessary.

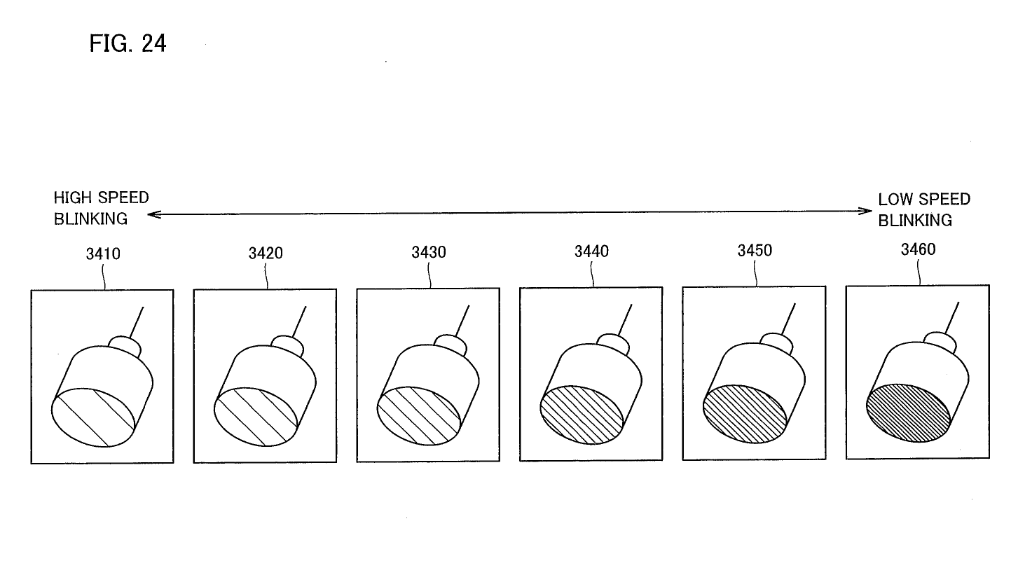

FIG. 24 illustrates a manner in which an image is displayed on display 172. Display apparatus 150 updates display of an image based on table 3300, and the image is displayed in a specified manner from high-speed blinking state to low-speed blinking state. By way of example, in the example shown in FIG. 24, an image 3410 is blinking at a high speed and has a luminance of 240 so that the lamp as displayed appears to be whitest. In the order of image 3420, image 3430, image 3440, image 3450, and image 3460, the speed of blinking decreases and the color of the displayed lamp changes from white (luminance 240) to black (luminance 0). Such a process can be repeated to allow display 172 to display the lamp in such a manner that the lamp is blinking and appears to become darker.

[Control Structure]

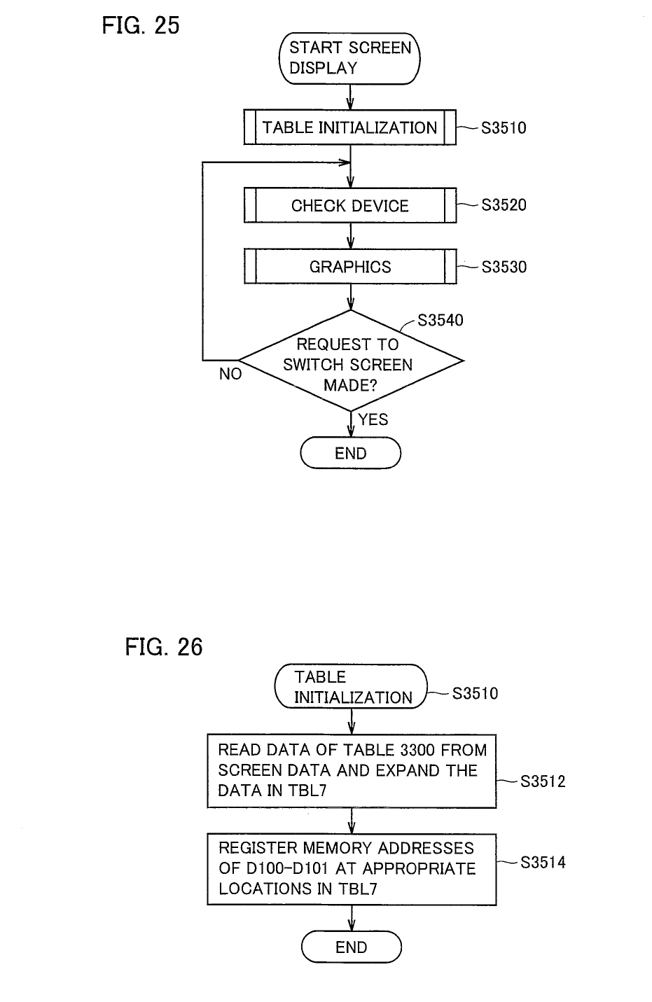

Referring to FIGS. 25 to 29, a description will be given of a control structure of display apparatus 150 according to the present embodiment.

(Main Flow)

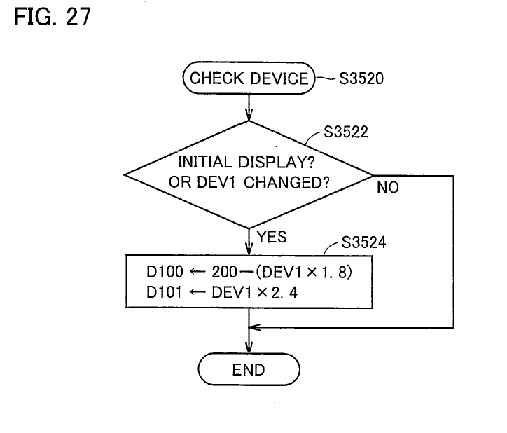

As shown in FIG. 25, in step S3510, CPU 152 executes table initialization as described hereinafter (FIG. 26). This step is executed, and the data of table 3300 is expanded in a memory region of VRAM 168. In step S3520, CPU 152 checks a device as described hereinafter (FIG. 27). This step is executed, and respective values of integer value storage memory addresses D100, D101 are updated.

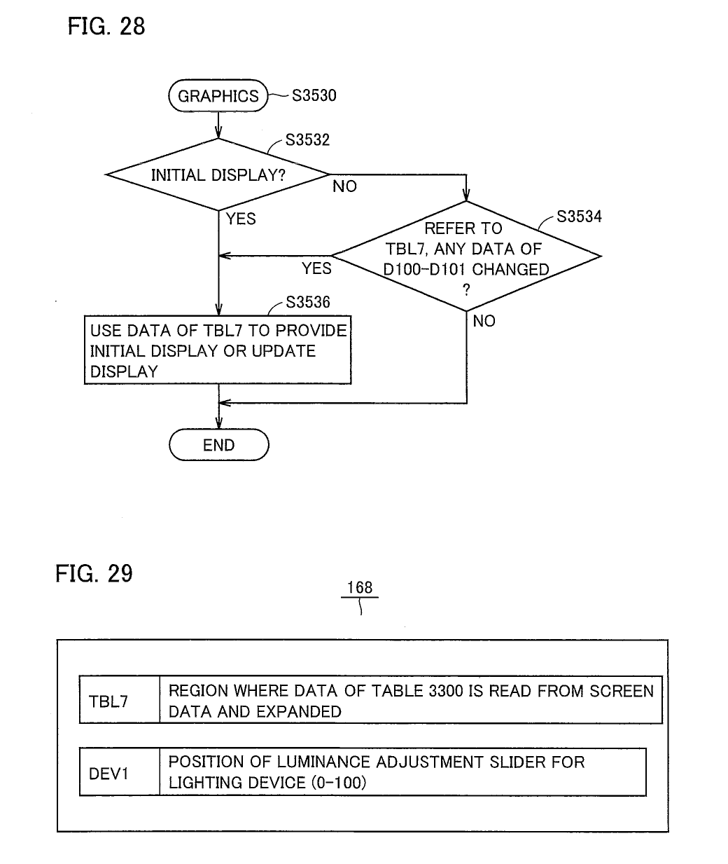

In step S3530, CPU 152 executes a graphics process as described hereinafter (FIG. 28). This step is executed, and display 172 displays image 3200 representing a lamp. In step S3540, CPU 152 determines whether or not a request to switch the screen shown on display 172 is made, based on data provided to display apparatus 150. When CPU 152 determines that such a request is made (YES in step S3540), CPU 152 ends the process. Otherwise (NO in step S3540), CPU 152 returns to step S3520.

(Table Initialization)

FIG. 26 illustrates a detailed flow of step S3510 in FIG. 25. In step S3512, CPU 152 reads the data of table 3300 from screen data and expands the read data in a memory region TBL 7. In step S3514, CPU 152 registers respective values of integer value storage memory addresses D 100, D101 at appropriate locations in memory region TBL 7. After this, CPU 152 returns to the main process.

(Checking of Device)

FIG. 27 illustrates a detailed flow of step S3520 in FIG. 25. In step S3522, CPU 152 determines whether or not display 172 is showing an initial display state or whether or not the value of a memory region DEV 1 is changed, based on data stored in memory 160 or data stored in VRAM 168. When CPU 152 determines that display 172 is showing the initial display state or that the value of memory region DEV 1 is changed (YES in step S3522), CPU 152 proceeds to step S3524. Otherwise (NO in step S3522), CPU 152 ends the process.

In step S3524, CPU 152 updates respective values of integer value storage memory addresses D100, D101. Specifically, CPU 152 writes the value determined by an expression “200−(DEV 1×1.8)” at integer value storage memory address D100. Further, CPU 152 writes the value determined by an expression “DEV 1×2.4” at integer value storage memory address D101.

(Graphics Process)

FIG. 28 illustrates a detailed flow of step S3530 in FIG. 25. In step S3532, CPU 152 determines whether or not display 172 is displaying an initial screen, based on data stored in memory 160. When CPU 152 determines that display 172 is displaying the initial screen (YES in step S3532), CPU 152 proceeds to step S3536. Otherwise (NO in step S3532), CPU 152 proceeds to step S3534.

In step S3534, CPU 152 refers to memory region TBL 7 to determine whether or not any of the data of integer value storage memory addresses D100, D101 is changed. When CPU 152 determines that any of the data is changed (YES in step S3534), CPU 152 proceeds to step S3536. Otherwise (NO in step S3534), CPU 152 ends the process. In step S3536, CPU 152 uses the data of TBL 7 to provide the initial display or update the display.

(Data Structure)

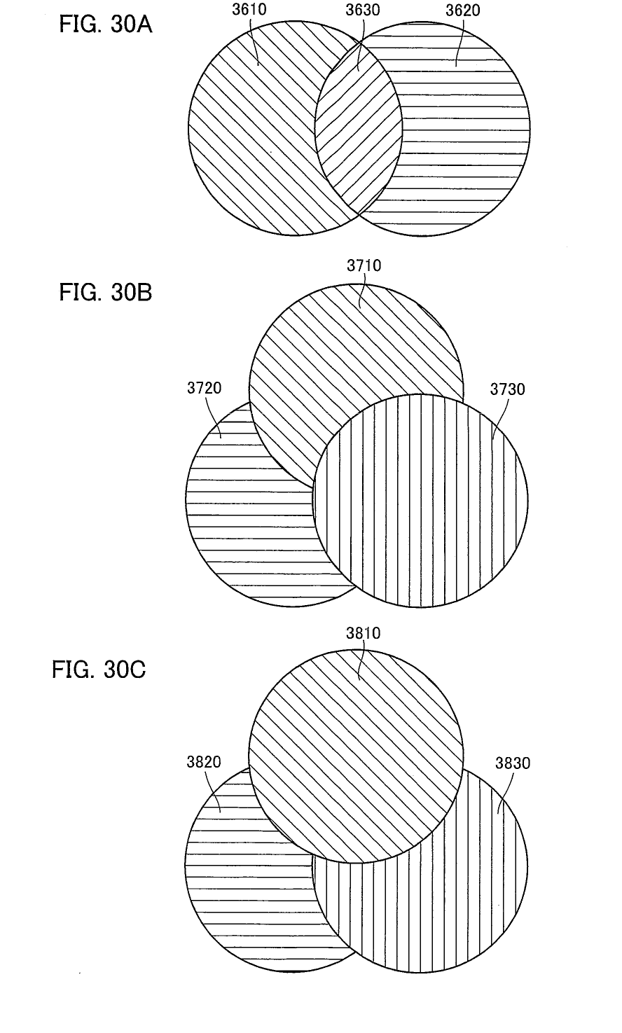

As shown in FIG. 29, VRAM 168 includes memory regions TBL 7, DEV 1. Memory region TBL 7 is used to expand data included in table 3300 read from the screen. Memory region DEV 1 is used for example for storing a value (0 to 100 for example) defining a slider that is used for adjusting the luminance of a lighting device associated with image 3200 displayed on display 172. The slider is used, for example, as a software module for adjusting the luminance.

Referring to FIGS. 30A to 30C, a description will be given of the case where the same pixel is acquired in a process using a plurality of color attribute change control tables.

Specifically, in the first, second or third embodiment, a plurality of tables may be used for one image like the case as shown in FIG. 30A where a plurality of tables acquire the same pixel. For example, in one embodiment, the region of the circle including a region 3610 is defined by table 2110, and a pixel in this region has a blue element of 255. Further, the circular region including a region 3620 is defined by table 2120, and a pixel in this region has a green element of 255. In this case, a region 3630 is defined as including both of the pixel of a blue element of 255 and the pixel of a green element of 255.

In this case, the order in which respective processes using respective tables are carried out should be considered. In the following, “table” or “n-th table” refers to a color attribute change control table such as tables 2110, 2120, 2130 or tables 2710, 2720, 2730, for example.

In the present embodiment, instead of the method according to which “a color attribute having been changed using a first table is obtained and the color attribute is changed using a second table,” a method may be used according to which “a color attribute of a pixel in an original image is obtained and changed” using each table. Thus, in the case where a first table and a second table are registered in this order in a memory and the tables are used successively, what is actually displayed when these tables acquire the same pixel is the result of the change of the color attribute using the second table (namely the change based on the table used later is shown). Under this rule, the following method for registering tables may be employed.

(1) “Management Table for Color Attribute Change Control Tables”

This management table specifies the order in which color attribute change control tables are registered, and allows the order to be changed so that a table and the preceding or following table in the registered order may be replaced with each other. Further, this management table indicates to a user of display apparatus 150 that, in the case where color attribute change control tables acquire the same pixel, the color attribute change control table registered later is valid.

(2) “Management Table for Priority-Applied Color Attribute Change Control Tables”

This management table applies priority to each color attribute change control table, and defines that a table with a higher priority is used later (namely valid). If a plurality of color attribute change control tables have respective priorities identical to each other, a color attribute change control table registered later is set valid.

FIG. 30B illustrates the state where “management table for color attribute change control tables” is applied in one embodiment. For example, a region 3710 is defined by the first table, a region 3720 is defined by the second table, and a region 3730 is defined by the third table. In this case, the management table includes the order in which the tables are registered, and the data identifying each color attribute change control table, and is defined as follows.

[Management Table for Color Attribute Change Control Tables]

[1] Second table: acquire a certain color attribute and change the hue of the color attribute to “green”

[2] First table: acquire a certain color attribute and change the hue of the color attribute to “red”

[3] Third table: acquire a certain color attribute and change the hue of the color attribute to “blue”

Based on the order of registration [1] to [3], actually the second table (region 3720), then the first table (region 3710), and then the third table (region 3730) are used for the display. Accordingly, an image is displayed where region 3710 overlaps region 3720 and region 3730 further overlaps these regions.

FIG. 30C illustrates the state where “management table for priority-applied color attribute change control tables” is applied in another embodiment. By way of example, a region 3810 is defined by the first table, a region 3820 is defined by the second table and region 3830 is defined by the third table. In this case, the management table includes the priority (high, low, for example) and the data identifying each table, and is defined as follows.

[Management Table for Priority-Applied Color Attribute Change Control Tables]

Low [1] Second table: acquire a certain color element and change the hue of the color attribute of the element to “green”

High [2] First table: acquire a certain color element and change the hue of the color attribute of the element to “red”

Low [3] Third table: acquire a certain color element and change the hue of the color attribute of the element to “blue”

In this case, the second and third tables have the same priority. Regarding the order in which the tables are registered, the second table is registered and thereafter the third table is registered. Thus, the second table (region 3820), then third table (region 3830) and then the first table (region 3810) are used in the display process. Accordingly, an image is displayed where region 3830 overlaps region 3820 and region 3810 further overlaps these regions.

While the priorities are defined in two stages (high-low) in the present embodiment, multi-stage priorities (16 stages, 128 stages, 256 stages for example) may also be used.

### Fourth Embodiment

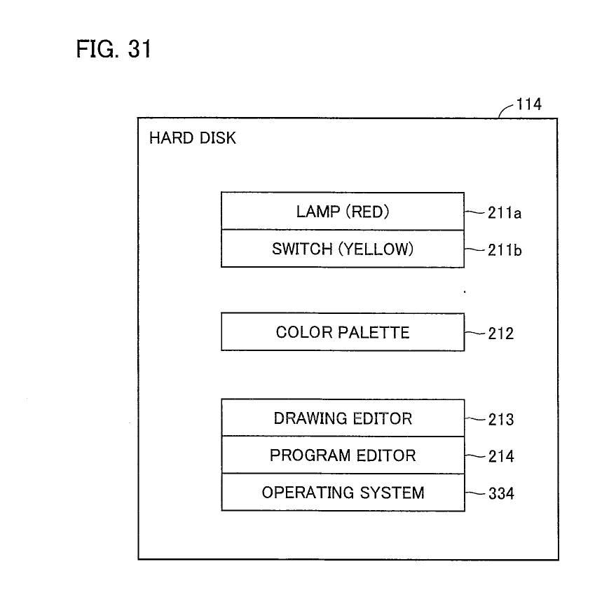

Referring to FIG. 31, a description will be given of a data structure of a screen editor apparatus 100 according to a fourth embodiment. A hard disk 114 stores, as a sample image 211 as prepared, an image 211a of a red lamp and an image 211b of a yellow switch. Images 211a, 211b correspond to sample image 211 in FIG. 2. Hard disk 114 also stores a color palette 212. Color palette 212 is constituted of a plurality of selectable hues arranged according to the hue angle for example.

Hard disk 114 further includes a drawing editor 213, a program editor 214 and an operating system 334. Drawing editor 213 causes CPU 110 and RAM 113 to function as a screen editor apparatus, for example. Program editor 214 supports creation of a control program in the case where display apparatus 150 has the control function. In the case where a common display apparatus without hard disk is used instead of display apparatus 150, program editor 214 is stored in an external storage device and program editor 214 operates on a personal computer for example. Operating system 334 controls basic input and output of screen editor apparatus 100 and communication with other information communication devices (display apparatus 150 for example).

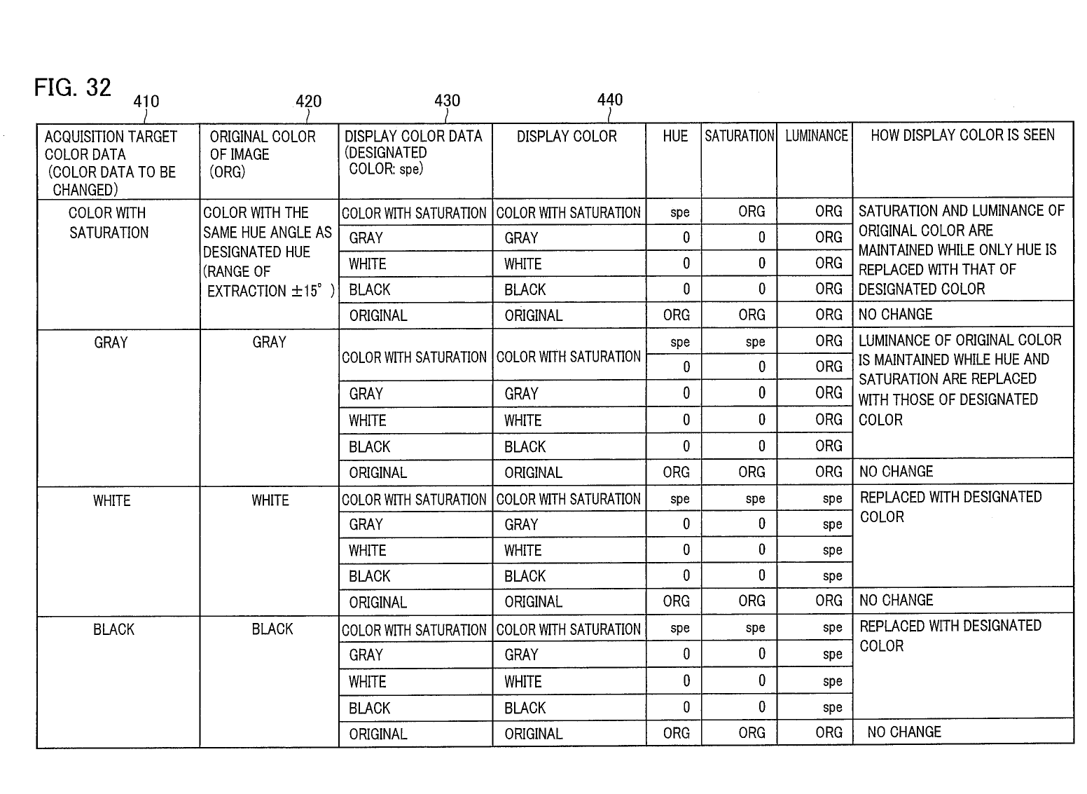

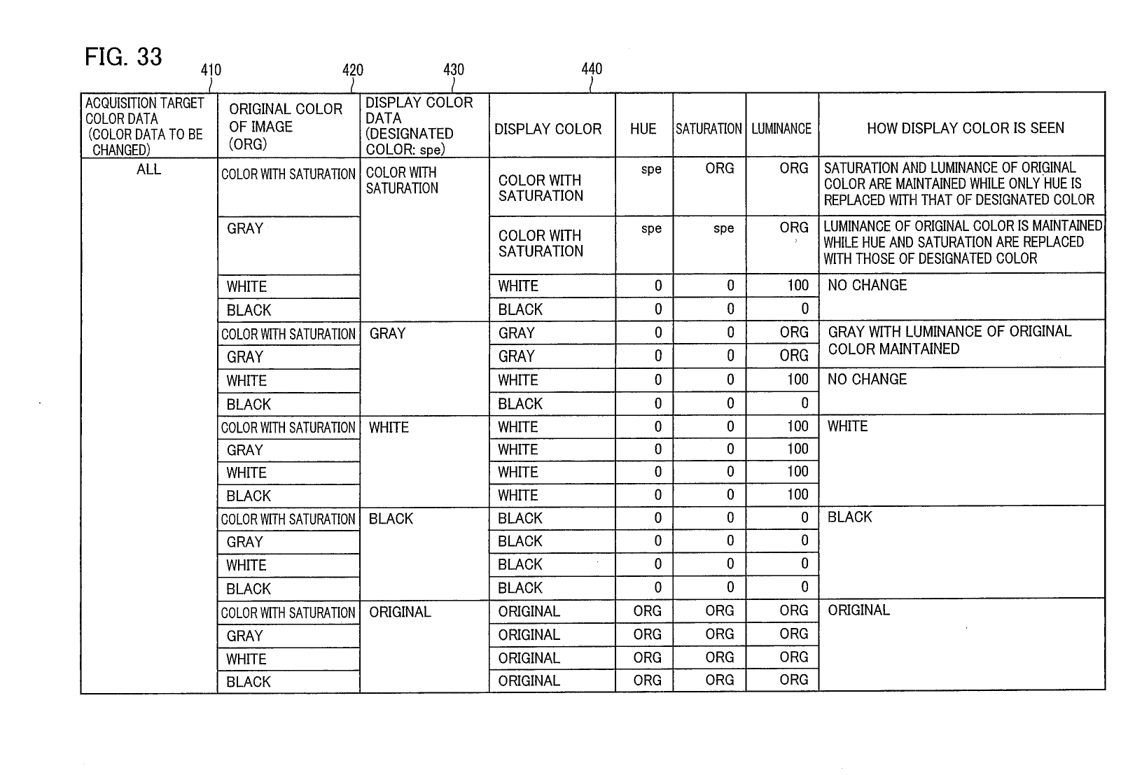

Referring to FIGS. 32 and 33, the case where color data is changed by display apparatus 150 in the present embodiment will be described.

(1) In the tables shown in FIGS. 32 and 33, acquisition target color data 410 refers to color data to be changed in a status indication image (image indicating a status of a target apparatus to be controlled) (the color data is also referred to as “change target color data”). In other words, acquisition target color data 410 is color data to be detected from the status indication image. In the present embodiment, any color may be acquired as the change target color data, namely acquisition target color data, even if the color is “color with saturation” or color without saturation such as “gray,” “white” and “black.” Further, “all” may also be acquired. “All” here refers to all of the colors that an image has. As the acquisition target color data, the original color data in a sample image may be acquired, or color data as displayed that has been changed from the original color data in a sample image may be acquired.

(2) In the case where the acquisition target color data in a sample image (“original color (ORG) of the image”) has saturation, the hue with a hue angle ranging from −15 degrees to +15 degrees with respect to the hue angle of the specified hue is acquired as the acquisition target color data. The hue angle is not limited to 15 degrees. In the case where “original color (ORG) of the image” is “gray,” “white” or “black,” “original color (ORG) of the image” corresponds to the acquisition target color data itself. In the case where the acquisition target color data is “all,” “original color (ORG) of the image” corresponds to “color with saturation,” “gray,” “white” and “black” extracted for each “change target color data.”

(3) Display color data 430 refers to color data specified by a user for changing the acquisition target color data of the status indication image. Display color data 430 may be specified as “color with saturation,” “gray,” “white,” “black” or “original.” “Original” refers to use of the color of the original image as it is. A description will be given of an example where a red lamp image is prepared as an original image. In the case where the lamp image is displayed in “blue” when a certain control target apparatus is “OFF” and the lamp image is displayed in “red” when the control target apparatus is “ON,” it is unnecessary to change the color data of the lamp image. In this case, “original” is specified as the color data used for “ON” so that the image is displayed in red as it is without change of the color data.

(4) Display color 440 refers to the color displayed on monitor 117 according to the specified acquisition target color data 410 and display color data 420. The display color includes “color with saturation,” “gray,” “white” and “black.” If the color of the sample image is used as it is, the display color is specified as “original.” In the case of “color with saturation,” the display color is changed by the change of the color data from the acquisition target color data to the display color data. In contrast, for the color without saturation such as “white,” “black” and “gray,” the display color remains unchanged even if the color data changes from the acquisition target color data to the display color data.

Under the conditions as described above, when “color with saturation” is selected as the acquisition target color data and “color with saturation” is selected as the display color data (spe), “color with saturation” is displayed on monitor 117. In this case, the color data is “spe” namely “color with hue” specified by a user. The saturation and the luminance are the saturation and the luminance of the original color (ORG) of sample image 211. Namely, the saturation and the luminance of the original image are maintained, and only the hue is changed to the color data (spe) specified by the user. In this case, the display color data can be selected from the color palette displayed on monitor 117, for example, and the user can easily select the color data to be displayed.

In the case where “color with saturation” is selected as the acquisition target color data and “gray” which is a color having the luminance only is selected as the display color data, monitor 117 displays the status indication image in gray after the change of the color. In this case, the hue and saturation are each “0.” The luminance is the luminance of the original color of the image.

As another example, in the case where “white” with the hue and saturation of 0 and the luminance of 100 is selected as the acquisition target color data and “color with saturation” is selected as the display color data, the hue, saturation and luminance of the status indication image are replaced with the hue, saturation and luminance of the color specified by the user.

Referring to FIG. 33, in the case where the acquisition target color data is “all,” the original color of the image is “white” and “color with saturation” is selected as “display color data,” the display color is still “white” since the luminance is “100.”

[Control Structure]

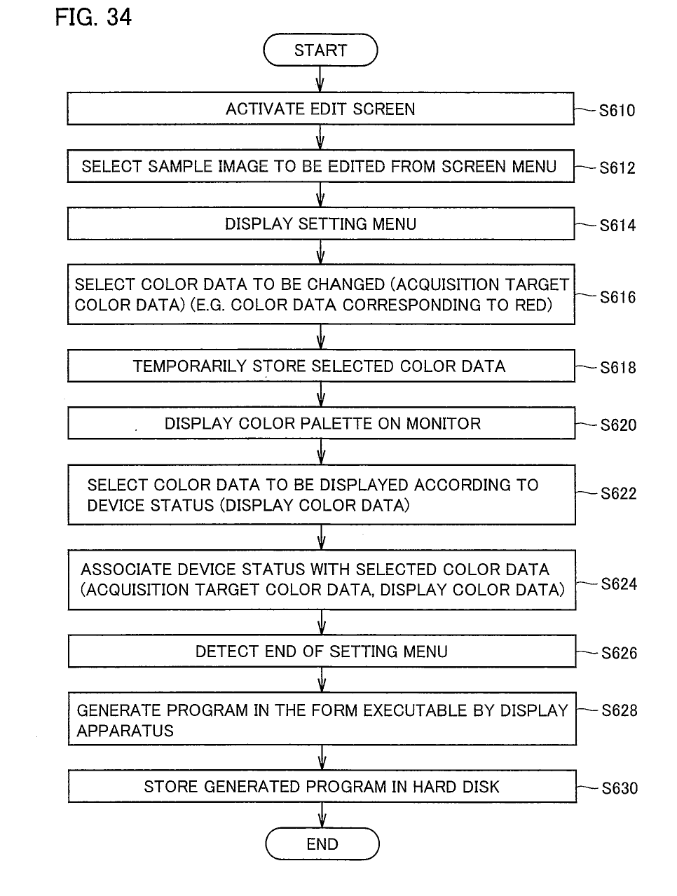

Referring to FIG. 34, a description will be given of a control structure of screen editor apparatus 100 according to the present embodiment.

In step S610, CPU 110 detects activation of an edit screen on monitor 117, based on a signal sent from mouse 111 or keyboard 112.

In step S612, CPU 110 selects a sample image to be edited, from an image menu displayed on monitor 117, based on selection given to screen editor apparatus 100. In step S614, CPU 110 causes monitor 117 to display a setting menu.

In step S616, CPU 110 detects selection of color data (acquisition target color data: color data corresponding to red for example) to be changed, based on a signal sent from mouse 111 or keyboard 112. In step S618, CPU 110 writes the selected color data (acquisition target color data) in RAM 113.

In step S620, CPU 110 causes monitor 117 to display color palette 212 stored in hard disk 114. Color palette 212 may have respective colors shown according to respective hue angles, or have these colors and additionally colors without hue such as white, or have colors displayed in the form of a list, for example. The color palette, however, is not limited to the above-described ones. The color palette may be any as long as the color palette is configured to allow a user of screen editor apparatus 100 to select color data from monitor 117 using the color palette.

In step S622, CPU 110 detects selection of color data to be displayed according to the status of a device, namely the display color data. “Device” here refers to any of control target apparatuses 196, 198 connected to display apparatus 150, for example, or control target apparatuses 192, 194 indirectly connected to display apparatus 150. The status of the device includes, for example, normal, abnormal, stop as well as possible statuses of production equipment or processing equipment for example.

In step S624, CPU 110 associates the device with the selected acquisition target color data and display color data, and stores the associated device and the associated color data in a region secured in RAM 113. In this way, sample image 211 is set as a status indication image.

In step S626, CPU 110 detects the end of the setting menu. In step S628, CPU 110 generates a program in the form executable by display apparatus 150. In step S630, CPU 110 stores the generated program in hard disk 114.

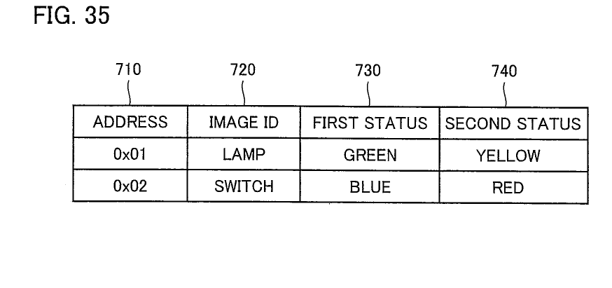

Referring to FIG. 35, a description will be given of a relation between an image and a status of a device in a control program generated by screen editor apparatus 100.

FIG. 35 illustrates a relation between an address 710 assigned to the device, an image ID 720, a first status 730, and a second status 740. First status 730 and second status 740 are distinguished from each other by a reference value set in advance. In the example shown in FIG. 35, data stored at address “0x0” is used for displaying a lamp. In the case where the device has the first status (normal status for example), the lamp is set to be displayed in green. When the device exceeds the reference value to enter the second status (abnormal status for example), the hue of the lamp is changed so that the lamp is displayed in “yellow.” At this time, the luminance and the saturation are not changed.

While the display color of the lamp is changed depending on whether or not the reference value is exceeded in the embodiment as described above, the color may be changed in proportion to the value indicating the device status. Further, the color may be changed successively or in stepwise manner according to a change of the value indicating the device status.

The relation as shown in FIG. 35 is just a conceptual one. When a control program is generated, the above-described relation is taken into the program.

[Manner of Display]

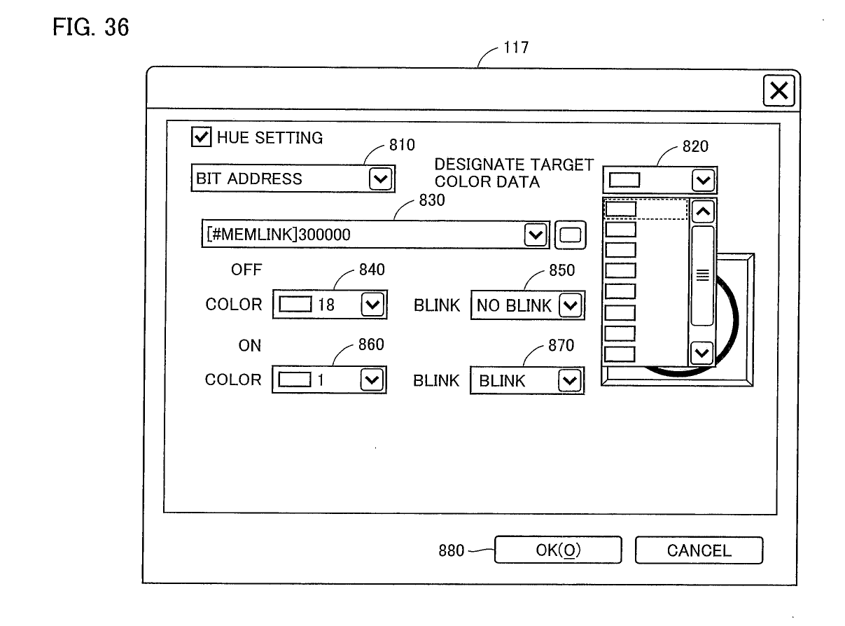

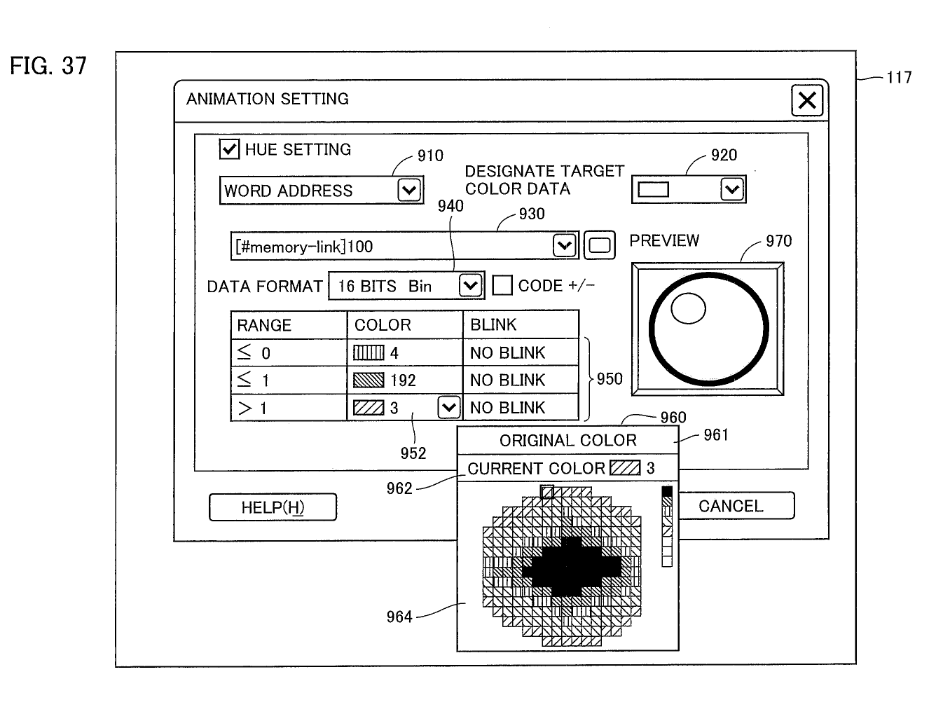

Referring to FIGS. 36 and 37, a manner in which a screen is displayed on screen editor apparatus 100 will be described.

Referring to FIG. 36, monitor 117 displays a menu screen for setting color data, for example. In this case, a bit address 810 taking on a value of 0 or 1 for example is displayed as an address of a target for which an image is to be set. When a certain operation is performed normally in a specific working process, it is unnecessary to light a lamp image for giving notice of abnormality. In this case, value “0” is assigned to bit address 810 and the lamp image is set OFF. In contrast, when the operation is not performed normally, it is necessary to light the lamp image for giving notice of the abnormality. In this case, value “1” is assigned to bit address 810. The values to be assigned in respective cases may be replaced with each other.

A palette used for selecting color data for an image of a part corresponding to bit address 810 is displayed in a region 820 in the form of a list, for example. The list is displayed in the form of a pull-down menu for example. The pull-down menu is displayed, for example, in descending or ascending order, according to the ratio between colors constituting the image. The ratio between the constituent colors is calculated, for example, based on the area of the displayed color data for each pixel. The manner in which the list is displayed is not limited to the pull-down menu, and any of other forms such as pop-up menu may be used as well.

A specific variable used for bit address 810 is displayed in the pull-down menu form in a region 830.

Regions 840, 850, 860, 870 are screen portions used for receiving selection of color data to be displayed according to the value of bit address 810. The screen portions are also displayed in the pull-down menu form. Acquisition target color data and display color data are assigned to a sample image to be used as a status indication image.

[Lamp OFF]

Regions 840, 850 are used to define display settings in the case where a process performed by a control target apparatus corresponding to the image normally works. In this case, because it is unnecessary to give notice of abnormality by the lamp image (status indication image), the lamp image is rendered OFF. In region 840, color data is specified. Specifically, color data of number 18 is specified. In region 850, the setting about whether or not the image should be blinked is received. In the case of “NO BLINK” as shown in FIG. 36, the image is not blinked.

[Lamp ON]

Regions 860, 870 are used to define display settings in the case where a process performed by a control target apparatus corresponding to the image does not normally work. In this case, it is necessary to give notice of abnormality, and the lamp image is rendered ON. In region 860, the color data is specified. Specifically, the color data of number 1 is specified. In region 870, the setting about whether or not the image should be blinked is received. In the case of “BLINK” as shown in FIG. 36, the image is blinked.

FIG. 37 shows a manner in which a screen is displayed on monitor 117 in the case where a word address is used as a variable. Monitor 117 displays, on the screen for setting color data, a word address 910, a menu 920 from which an item can be selected for setting target color data, a list of variables 930, a region 940 showing a data format, a region 950 for making settings for color data constituting an image assigned to the variable, a pop-up menu 960, and a preview image 970.

The word address defines the address of the variable in the case where the variable assigned to the device is in the word format. At “set target color data,” selection of color data to be changed in a target image is received. “Color data to be changed” here includes both of the acquisition target color data and the display color data. The variable corresponds to the name of the variable used for the word address. When a user of screen editor apparatus 100 selects a word address, the variable displayed in region 930 is changed.

In the example shown in FIG. 37, display of the color data with a value larger than 1 is selected as a target for which settings are made at present. Specifically, the color data with number 3 (red for example) is selected as shown in a region 952. When the user of screen editor apparatus 100 selects the pop-up menu, pop-up menu 960 is displayed. Pop-up menu 960 includes regions 961, 962, 964.

In region 961, operational input for creating or setting an original color is received. In region 962, the currently selected color data (red with number 3 for example) and the number for identifying the color data are displayed.

In region 964, a color palette 212 prepared for changing the settings for the color data is displayed. When the user operates mouse 111 or keyboard 112 to change the selection of color data on color palette 212, the change is reflected on preview 970.

[Control Structure]

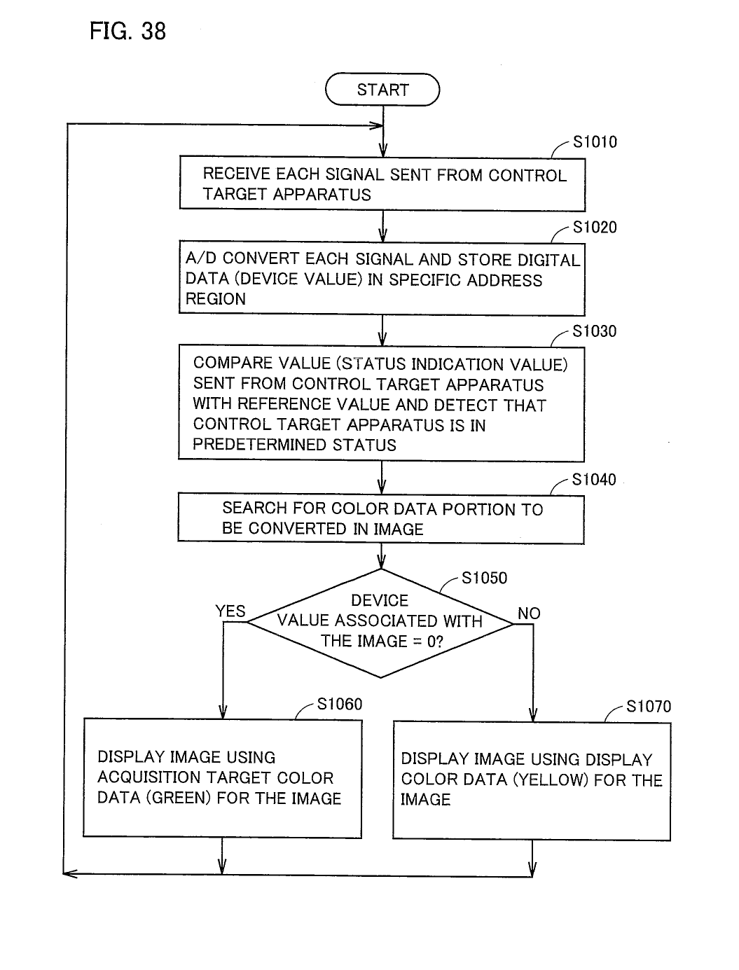

Referring to FIG. 38, an operation of display apparatus 150 using a display program generated by screen editor apparatus 100 will be described.

In step S1010, CPU 152 receives a signal sent from control target apparatus 196, 198 (control target apparatus 192, 194). In step S1020, CPU 152 stores, in a specified address region, digital data (device value) into which the signal is converted. The address region is stored for example in DRAM 162.

In step S1030, CPU 152 compares a value sent from the control target apparatus (status indication value) with a reference value and detects that the control target apparatus becomes a predetermined status. Here, reference value refers to a value defined in advance such that the color data of an image indicating the status of the control target apparatus is to be changed from acquisition target color data to display color data, based on the reference value. For example, if the acquisition target color data is to be changed to the display color data when the temperature of the control target apparatus exceeds T degrees, the temperature (T degrees) is the reference value.

In the present embodiment, the acquisition target color data is changed to the display color data depending on whether or not the value sent from the control target apparatus exceeds the reference value. Alternatively, for example, the acquisition target color data may be changed to the display color data successively or in stepwise manner in proportion to a change of the value sent from the control target apparatus. By way of example, the image may be displayed with the acquisition target color data at T1 degrees, the image may be displayed with the display color data at T2 degrees, and, at a temperature between T1 degrees and T2 degrees, the image may be displayed with the ratio between the acquisition target color data and the display color data changed according to the temperature.

In step S1040, CPU 152 searches for a color data portion to be changed in the image. CPU 152 for example successively reads respective color codes associated with a plurality of pixels constituting the image to search for the color data portion.

In step S1050, CPU 152 determines whether or not the device value associated with the image is “0.” when the device value is “0” (YES in step S1050), CPU 152 proceeds to step S1060. Otherwise (NO in step S1050), CPU 152 proceeds to step S1070.

In step S1060, CPU 152 displays the image with the acquisition target color data (green for example) specified as color data to which the color of the image is to be changed. Display 172 then displays a lamp in green. In step S1070, CPU 152 displays the image with the display color data (yellow, for example) for the image. CPU 152 thereafter returns to step S1010.

[Functional Configuration]

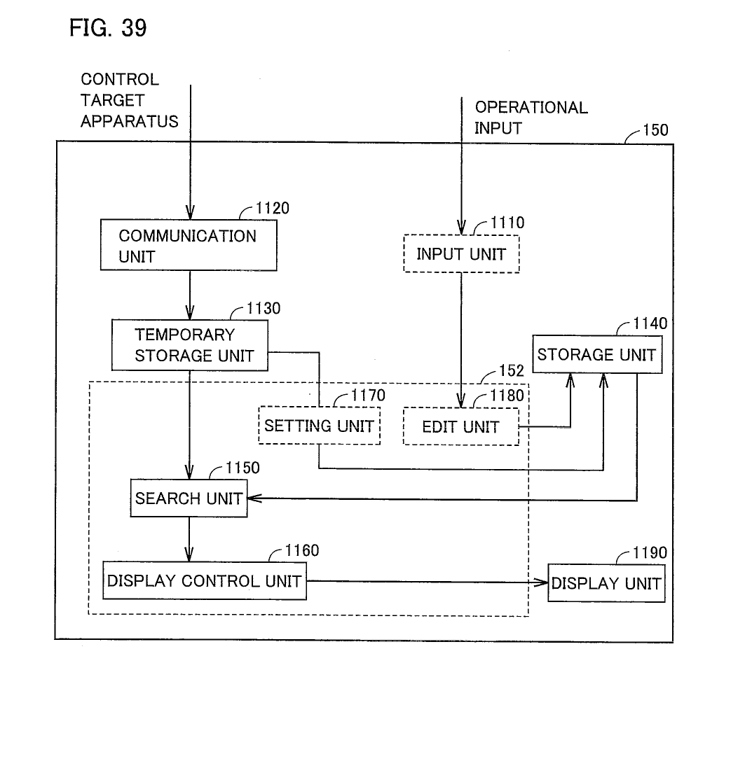

Referring to FIG. 39, a description will be given of a configuration of display apparatus 150 according to an embodiment of the present invention. Display apparatus 150 includes an input unit 1110, a communication unit 1120, a temporary storage unit 1130, a storage unit 1140, a search unit 1150, a display control unit 1160, a setting unit 1170, an edit unit 1180, and a display unit 1190. Search unit 1150, display control unit 1160, setting unit 1170, and edit unit 1180 are implemented by CPU 152, for example.

Input unit 1110 receives operational input to display apparatus 150. Input unit 1110 is implemented for example by touch panel 174, keyboard (not shown) or the like.

Communication unit 1120 communicates with PLC 180 or control target apparatuses 196, 198. Communication unit 1120 receives device data sent from PLC 180 or device data sent from control target apparatuses 196, 198. Communication unit 1120 may transmit, to control target apparatuses 192, 194, 196, 198, a request to send data indicating a status of the control target apparatuses, or a request to send a set value for display color data of an image indicating a status of each control target apparatus.

Temporary storage unit 1130 temporarily (in volatile manner) holds data received by communication unit 1120. Storage unit 1140 holds in nonvolatile manner the data that is output from setting unit 1170 or edit unit 1180. Storage unit 1140 is implemented as FEPROM 164 for example. Storage unit 1140 stores a group of display color data for displaying color data to which the color is to be changed. As described hereinafter, the group of display color data may be provided from the outside of display apparatus 150. For example, the source of the group of display color data may be a recording medium storing the group of display color data, or information communication system capable of transmitting the group of display color data. Temporary storage unit 1130 is implemented for example by DRAM 162.

More specifically, storage unit 1140 stores a group of acquisition target color data, a group of display color data and a reference value. Search unit 1150 determines whether or not a status indication value exceeds the reference value that is defined in advance as a criterion based on which the display color of a status indication image is changed. For a control target apparatus exceeding the reference value, search unit 1150 specifies a portion to be changed portion displayed with the acquisition target color data) in the status indication image. Display control unit 1160 changes the portion specified as a result of the search by search unit 1150 to the color data (display color data) associated with the status, and causes display unit 1190 to display the status indication image.

Setting unit 1170 may be configured to receive input of a group of display color data from any source outside display apparatus 150, and store the group of display color data in storage unit 1140.

In the case where a group of display color data is stored in an external apparatus such as a control target apparatus located outside display apparatus 150, display apparatus 150 may be configured to obtain the group of display color data from the control target apparatus according to an instruction stored in the external apparatus. In this case, setting unit 1170 may be configured to access the control target apparatus and store, in storage unit 1140, second color data selected from a second group of color data stored in the control target apparatus.

Storage unit 1140 may be configured to store, instead of the acquisition target color data, an instruction to select acquisition target color data from a group of acquisition target color data, and store, instead of the display color data, an instruction to select display color data from a group of display color data.

Display apparatus 150 may include edit unit 1180. Preferably, edit unit 1180 causes display unit 1190 to display a sample image prepared as an image. Edit unit 1180 receives input for selecting a display color (acquisition target color data) to be changed, from one or more colors constituting the sample image. Edit unit 1180 causes display unit 1190 to display a plurality of color data candidates available as a display color (display color data) to which the selected display color is to be changed. Edit unit 1180 receives input for selecting display color data to which the color is to be changed, from a plurality of color data candidates.

Preferably, edit unit 1180 causes display unit 1190 to display a palette constituted of a plurality of color data, as a plurality of color data candidates. Alternatively, edit unit 1180 may cause display unit 1190 to display a list of a plurality of color data, as a plurality of color data candidates. Further, edit unit 1180 calculates the ratio of constituent color data of the sample image, namely the area occupied by the constituent color data, based on a bit map constituting the sample image. Based on the order of respective ratios of color data as calculated, edit unit 1180 causes display unit 1190 to display the constituent color data.

While display apparatus 150 shown in FIG. 39 includes setting unit 1170 and edit unit 1180, these elements are not indispensable for the configuration. Further, the above-described operation by edit unit 1180 is performed in the case where display apparatus 150 functions as screen editor apparatus 100. This operation is usually performed by screen editor apparatus 100 having the edit capability. In other words, display apparatus 150 and screen editor apparatus 100 are provided as separate apparatuses.

[Data Structure]

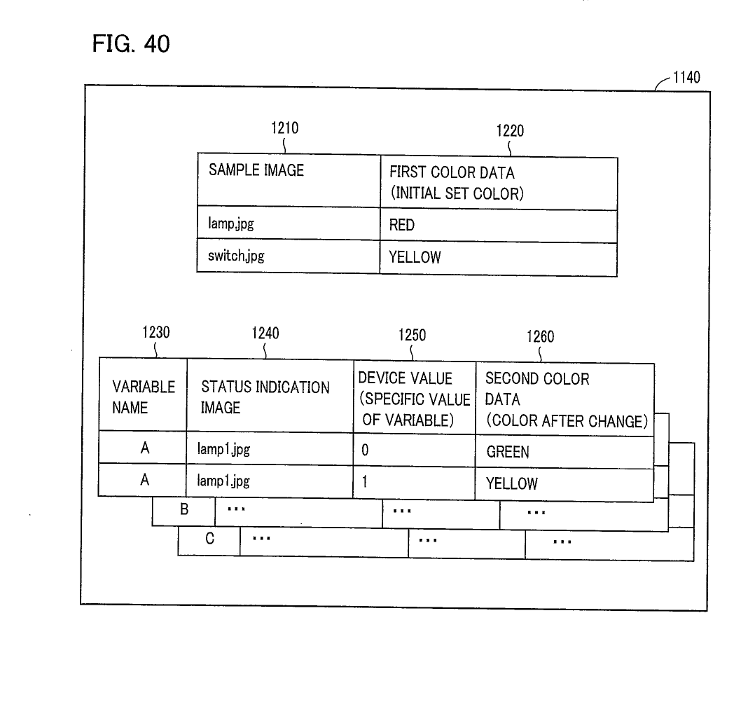

Referring to FIG. 40, a description will be given of a data structure of display apparatus 150 according to the present embodiment. Storage unit 1140 is configured as a nonvolatile memory such as FEPROM 164, for example. Storage unit 1140 includes a plurality of memory regions for storing data.

A sample image is stored in a memory region 1210. First color data is stored in a memory region 1220. The first color data is set in advance as an initial setting value for displaying the sample image. In the example shown in FIG. 40, “red” is set as original color data for sample image “lamp.jpg.”

Storage unit 1140 further includes memory regions 1230, 1240, 1250, 1260. A variable name is stored in memory region 1230. A status indication image associated with the variable name is stored in memory region 1240. A device value (specific value of the variable) is stored in memory region 1250. The device value, namely status indication value, is associated with the variable name and the status indication image. Second color data is stored in memory region 1260. Second color data is used for displaying the status indication image with specific color data when the status indication value exceeds a reference value.

In the example shown in FIG. 40, variable “A” is associated with status indication image “lamp.jpg.” The status indication image in memory region 1240 is the same as the sample image in memory region 1210. The device value is set to “0”. “Green” is set as second color data.

In contrast, when the device value is “1” for variable “A,” “yellow” is set as second color data. Therefore, when the value of variable “A” is “0,” status indication image “lamp.jpg” is displayed in “green.” In contrast, when the value of the variable is “1,” the status indication image is displayed in “yellow.” In this case, while original color data is “red” only, the color data may be changed to the color data defined by the first and second color data, so that the status indication image may be displayed in another color.

[Data Structure of Control Target Apparatus]

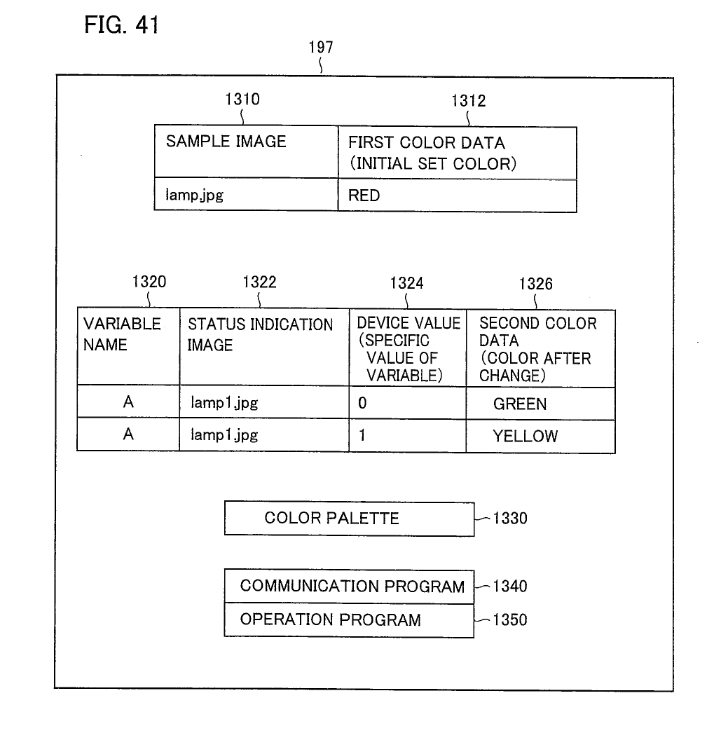

Referring to FIG. 41, a description will be given of a data structure of control target apparatus 196 according to an embodiment of the present invention. Nonvolatile memory 197 includes memory regions 1310, 1312, 1320, 1322, 1324, 1326, 1330, 1340, 1350 for storing data.

Sample image “lamp.jpg” is stored in memory region 1310. Original color data (first color data) is stored in memory region 1312.

A variable name is stored in memory region 1320. The status indication image associated with the variable is stored in memory region 1322. The device value taken by the variable is stored in memory region 1324. The color to be displayed according to the device value is stored in memory region 1326, as second color data to be selected by a user. In the example shown in FIG. 41, in the case where the value of variable “A” is “0,” status indication image “lamp1.jpg” is displayed in “green” that is the first color data.

A communication program is stored in memory region 1340. The communication program implements communication between control target apparatus 196 and display apparatus 150. An operation program functions as an operating system for control target apparatus 196.

[Control Structure]

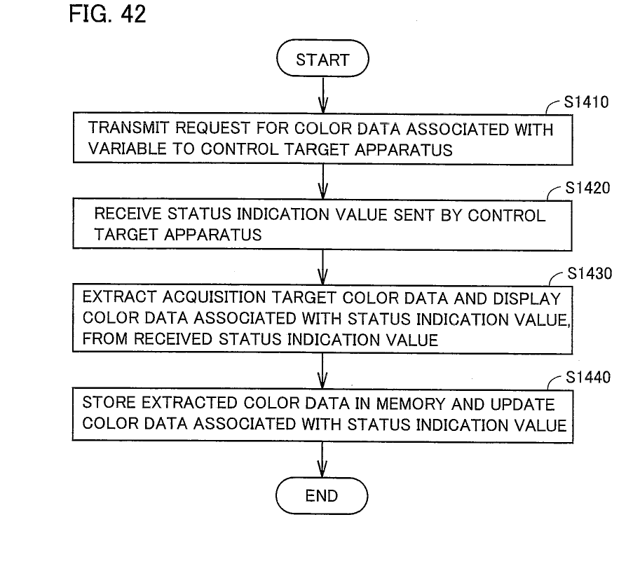

Referring to FIG. 42, a description will be given of a control structure of display apparatus 150 according to an embodiment of the present invention.

This process is performed, for example, in the case where the operation mode of display apparatus 150 is “setting mode based on data from a control target apparatus.”

In step S1410, CPU 152 requests control target apparatus 196 to transmit a status indication value. Specifically, CPU 152 transmits a request for color data associated with a variable. Control target apparatus 196 executes the communication program (memory region 1340) to read data stored in memory regions 1320 to 1326 and transmit the status indication value according to the request to display apparatus 150.

In step S1420, CPU 152 receives the status indication value sent by control target apparatus 196.

In step S1430, CPU 152 extracts, from the received status indication value, acquisition target color data and display color data associated with the status indication value, into a region secured in DRAM 162.

In step S1440, CPU 152 stores the extracted color data in FEPROM 164 (FIG. 40) and updates the color data associated with the status indication value.

In this way, display apparatus 150 in the embodiment of the present invention stores the acquisition target color data and the display color data different from the color data of the sample image as prepared (original color data), as well as the status indication value, with the acquisition target color data and the display color data associated with the status indication value (FIG. 41). Display apparatus 150 displays the status indication image using the acquisition target color data and the display color data based on the status indication value. Thus, it is unnecessary to prepare respective images for a plurality of color data.

Further, since it is unnecessary for a user to rewrite the attribute of a part in a program code, an error in the program code is prevented. Accordingly, a problem that the user cannot achieve intended rewrite can be prevented.

Further, even in the case where a user is to use a part that is not prepared by the manufacture of a screen editor apparatus or screen editing software, it is unnecessary for the user to newly produce all images. Using one image of a part, the user can easily display a part image having the same structure and different color data on the display apparatus. Accordingly, even those users unaccustomed to operating common bitmap image editing software or users without talent for drawing or painting can easily generate a complicated image with saturation, luminance and hue, such images prepared as standard images. By way of example, the user can express a heating boiler by changing the color data of one boiler image to warm-color data, and express an excessively cooled boiler by changing the color data of the boiler image to cold-color data.

Further, it is unnecessary for the provider of a screen editor apparatus or screen editing software to prepare respective colors of respective parts that may possibly be used. Thus, those parts that may not be used eventually are not included in the screen editor apparatus or screen editing software, so that a user can easily find a part image that the user wants to use.

Moreover, based on an image of a lamp whose picture is actually taken or an image created by an expert designer, a user can set a screen display program so that the image with color data changed is displayed. Accordingly, a more realistic expression or depiction can be made by display apparatus 150. In the case where outsourcing is done for drawing based on a picture as taken, a user may only order drawing for an image in a standard color. An increase in outsourcing cost can thus be suppressed.

As detailed above, display apparatus 150 in each embodiment achieves display of an image in various manners using one graphics object including an image and a necessary number of “color attribute change control tables” for displaying separate colors in the image.

Thus, as compared with the case where display is achieved by combining a plurality of images and a plurality of graphics objects, the amount of data for graphics can be prevented from increasing and the speed of graphics operation can be prevented from becoming slower. Further, one graphics object may be copied and pasted to duplicate the graphics operation, so that the convenience in drawing can be enhanced. In addition, seamless graphics color change can be achieved.

According to the description above, screen editor apparatus 100 is implemented by a combination of software and hardware using a computer system having a well-known configuration. The configuration of screen editor apparatus 100 in each embodiment, however, is not limited to the above-described one. For example, screen editor apparatus 100 may also be implemented by hard-wired circuits, for example.

Although the present invention has been described and illustrated in detail, it is clearly understood that the same is by way of illustration and example only and is not to be taken by way of limitation, the scope of the present invention being interpreted by the terms of the appended claims.

1. A display apparatus connectable to a control target apparatus, said display apparatus comprising:
a display main body;
a transmitter for transmitting an instruction to said control target apparatus;
an input unit for receiving input of data that is output by said control target apparatus;
a memory configured to store first color data specifying a color attribute designated as a target to be acquired in an image displayed on said display main body; and
a processor coupled to said memory,
said processor being configured to:
acquire the first color data in the image displayed on said display main body, based on the data output by said control target apparatus;
determine whether it is necessary to change the first color data in the image displayed on said display main body; and change the color attribute of the first color data when said processor determines that it is necessary to change the first color data.

2. The display apparatus according to claim 1, wherein
said memory is further configured to store second color data specifying a color attribute, and
said processor is further configured to change the color attribute of the first color data to the color attribute of the second color data.

3. The display apparatus according to claim 1, wherein
said memory is further configured to store a plurality of color data and
said processor is further configured to:
produce a color data table arranging a predetermined number of color data in descending order in terms of size of an area occupied by the color data in the image displayed on the display main body;
cause said display main body to display said color data table; and
receive selection for setting said first color data.

4. A method for displaying an image, comprising the steps of:
loading, into a memory, first color data for specifying a color attribute designated as a target to be acquired in an image displayed on a display apparatus;
acquiring the first color data in the image displayed on said display apparatus, based on data that is output by a control target apparatus connected to said display apparatus;
determining whether it is necessary to change the first color data in the image displayed on said display apparatus; and
changing the color attribute of the first color data when determining that it is necessary to change the first color data.

5. The method according to claim 4, further comprising the steps of:
loading, into said memory, second color data specifying a color attribute; and
changing the color attribute of the first color data to the color attribute of the second color data.

6. The method according to claim 4, further comprising the steps of:
loading a plurality of color data into said memory;
producing a color data table arranging a predetermined number of color data in descending order in terms of size of an area occupied by the color data in the image displayed on the display apparatus;
causing said display apparatus to display said color data table; and
receiving selection for setting said first color data.

7. A computer-readable recording medium storing a program for causing the method as recited in claim 4 to be executed.

8. A display apparatus for displaying a status indication image indicating a status of a control target apparatus, based on input of a status indication value indicating the status of said control target apparatus, said display apparatus comprising:
a display unit;
a storage unit configured to store: a reference value set in advance as a criterion for a value indicating a status of said control target apparatus; a group of first color data including a plurality of color data selectable as an attribute of a display color for at least a part of the status indication image displayed until the status indication value reaches the reference value; and a group of second color data including a plurality of color data selectable as an attribute of a display color for at least a part of the status indication image displayed when the status indication value exceeds the reference value; and
a controller configured to cause a display main body to display at least a part of the status indication image with the first color data, and cause the display main body to display at least a part of the status indication image with the second color data when the status indication value exceeds the reference value.

9. The display apparatus according to claim 8, further comprising a volatile memory for storing the reference value.

10. The display apparatus according to claim 8, wherein
at least one of the first color data and the second color data is input from outside the display apparatus.

11. The display apparatus according to claim 8, wherein
said storage unit is further configured to store a group of images including a plurality of sample images selectable as the status indication image, and
said display apparatus further comprises an editor configured to edit screen data, and
said editor is further configured to:
cause the display main body to display a sample image;
receive selection input for selecting first color data to be changed, from at least one color data constituting the sample image;
cause the display main body to display a plurality of color data candidates available as color data when the status indication value exceeds said reference value;
receiving selection input for selecting second color data to which the first color data is to be changed, from a plurality of color data candidates; and
produce screen data for displaying a portion displayed with the first color data, with the second color data when the status indication value exceeds said reference value.

12. The display apparatus according to claim 8, wherein
said editor is further configured to cause the display main body to display a palette including a plurality of color data as a plurality of color data candidates.

13. The display apparatus according to claim 8, wherein
said editor is further configured to cause the display main body to display a list of a plurality of color data as a plurality of color data candidates.

14. The display apparatus according to claim 8, wherein
said editor is further configured to calculate a ratio between constituent color data constituting a sample image, based on a bit map constituting the sample image, and cause the display main body to display the constituent color data in an order based on the ratio.

15. A screen editor apparatus for producing screen data used by a display program executed by the display apparatus as recited in claim 8, said screen editor apparatus comprising:
a memory for storing a plurality of sample images selectable as a status indication image, and a screen edit program;
an input interface for receiving input of an instruction;
a display main body; and
a processor coupled to said memory,
said processor being configured to:
cause said display main body to display a sample image by executing the screen edit program;
receive input for selecting first color data to be changed, from attributes of display colors of the sample image;
cause said display main body to display a plurality of color data candidates available as second color data;
receive input for selecting second color data from said plurality of color data candidates; and
produce the screen data for displaying a portion displayed with the first color data, with the second color data when said status indication value exceeds a reference value.

16. The screen editor apparatus according to claim 15, wherein
said processor is further configured to cause said display main body to display a palette including a plurality of color data as a plurality of color data candidates.

17. The screen editor apparatus according to claim 15, wherein
said processor is further configured to cause said display main body to display a list of a plurality of color data as said plurality of color data candidates.

18. The screen editor apparatus according to claim 15, wherein
said processor is further configured to calculate a ratio between constituent color data constituting a sample image based on a bit map constituting the sample image, and cause said display main body to display the constituent color data in an order based on said ratio.

19. A method for displaying an image indicating a status of a control target apparatus, comprising the steps of:
loading a status indication image, a reference value set in advance as a criterion for a value indicating the status of the control target apparatus, a group of first color data including a plurality of color data selectable as an attribute of a display color for at least a part of the status indication image displayed until a status indication value reaches the reference value, and a group of second color data including a plurality of color data selectable as an attribute of a display color for at least a part of the status indication image displayed when the status indication value exceeds the reference value;
selecting first color data from the group of first color data and selecting second color data from the group of second color data; and
causing a display main body to display a portion displayed with the first color data, with the second color data when the status indication value exceeds the reference value.

20. A program for causing a computer to implement a method for displaying an image indicating a status of a control target apparatus, said program causing said computer to execute the steps of:
loading a status indication image, a reference value set in advance as a criterion for a value indicating the status of the control target apparatus, a group of first color data including a plurality of color data selectable as an attribute of a display color for at least a part of the status indication image displayed until a status indication value reaches the reference value, and a group of second color data including a plurality of color data selectable as an attribute of a display color for at least a part of the status indication image displayed when the status indication value exceeds the reference value;
selecting first color data from the group of first color data and selecting second color data from the group of second color data; and
causing a display main body to display a portion displayed with the first color data, with the second color data when the status indication value exceeds the reference value.
